(19) United States
(12) Patent Application Publication
(10) Pub. No.: US 2022/0241665 A1
(43) Pub. Date: Aug. 4, 2022

(54) EXERCISE STORAGE SYSTEM

(71) Applicant: iFIT Inc., Logan, UT (US)

(72) Inventors: William T. Dalebout, North Logan, UT (US); Michael L. Olson, Providence, UT (US)

(21) Appl. No.: 17/589,027

(22) Filed: Jan. 31, 2022

Related U.S. Application Data
(60) Provisional application No. 63/144,241, filed on Feb. 1, 2021.
(60) Provisional application No. 63/187,348, filed on May 11, 2021.

(51) Int. Cl. A63B 71/00

(52) U.S. Cl. CPC A63B 71/0036; A63B 2225/50; A63B 2225/09

(57) ABSTRACT

An exercise storage system includes a storage compartment including at least one storage element. Exercise equipment is stored on the storage elements. A door is connected to the storage compartment with a hinge such that the viewing angle of the door is adjustable. A display on the door includes a backlit display and a mirrored display. A user may select exercise equipment from the storage compartment and perform an exercise activity while viewing the display.

### CROSS-REFERENCE TO RELATED APPLICATIONS

This application claims priority to and the benefit of U.S. Provisional Patent Application No. 63/144,241, filed on Feb. 1, 2021, and claims priority to and the benefit of U.S. Provisional Patent Application No. 63/187,348, filed on May 11, 2021, which are hereby incorporated by reference in their entireties.

### BACKGROUND

### Background and Relevant Art

Exercise equipment may take up a large volume of space. To save space, a storage system, such as a cabinet or shelves, may be used to store the exercise equipment. Furthermore, exercise facilities may include one or more displays, in which a user may observe and/or participate in an exercise program. Exercise facilities may also include one or more mirrors, in which the user may observe him or herself performing an exercise. The storage system may be separated from the display and/or the mirrors, thereby wasting time and effort by the user to transfer exercise equipment from the storage system to the display or the mirrors.

### BRIEF SUMMARY

In some embodiments, an exercise storage system includes a mirrored display having a mirrored surface and a backlit display. A tracking sensor is configured to sense a position of an object relative to the mirrored surface and a motor changes a position of the mirrored display based on the sensed position of the object. In some embodiments, the mirrored display is split between a first portion and a second portion. In some embodiments, the mirrored display is mounted to a cart having wheels or other motive element.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a perspective view of a representation of an exercise storage system, according to at least one embodiment of the present disclosure;

FIG. 2 is another perspective view of the exercise storage system of FIG. 1;

FIG. 3 is a front view of a representation of an exercise storage system, according to at least one embodiment of the present disclosure;

FIG. 4 is another front view of a representation of an exercise storage system, according to at least one embodiment of the present disclosure;

FIG. 5 is a side view of a representation of an exercise storage system, according to at least one embodiment of the present disclosure;

FIG. 6 is a representation of an exercise storage system, according to at least one embodiment of the present disclosure;

FIG. 7 is another representation of an exercise storage system, according to at least one embodiment of the present disclosure;

FIG. 8 is yet another representation of an exercise storage system, according to at least one embodiment of the present disclosure;

FIG. 9 is still another representation of an exercise storage system, according to at least one embodiment of the present disclosure;

FIG. 10-1 through FIG. 10-4 are representations of an exercise system including a mirrored display in various positions, according to at least one embodiment of the present disclosure;

FIG. 11-1 and FIG. 11-2 are representations of another exercise system including a mirrored display in various positions, according to at least one embodiment of the present disclosure;

FIG. 12 is a representation of yet another exercise system, according to at least one embodiment of the present disclosure;

FIG. 13 is a representation of still another exercise system, according to at least one embodiment of the present disclosure;

FIG. 14 is a representation of a method for tracking an exercise, according to at least one embodiment of the present disclosure;

FIG. 15 is a representation of another method for tracking an exercise, according to at least one embodiment of the present disclosure; and

FIG. 16-1 and FIG. 16-2 are representations of an exercise system with a rotatable mirrored display, according to at least one embodiment of the present disclosure;

FIG. 17-1 through FIG. 17-3 are representations of an exercise system with a split mirrored display, according to at least one embodiment of the present disclosure;

FIG. 18-1 is a representation of a mobile display, according to at least one embodiment of the present disclosure; and

FIG. 18-2 is a representation of the mobile display of FIG. 18-1 in a room having multiple exercise devices, according to at least one embodiment of the present disclosure.

### DETAILED DESCRIPTION

This disclosure generally relates to devices, systems, and methods for exercise storage systems. Exercise storage systems of the present disclosure may include a door with a display. The display may include a backlit display and a mirrored surface. In some embodiments, the backlit display may be visible through the mirrored surface and the mirrored surface may provide a visible reflection of people and objects while the backlit display is running. The display may be located on a door, which opens to allow the user to access and use exercise equipment within a cabinet while viewing the display.

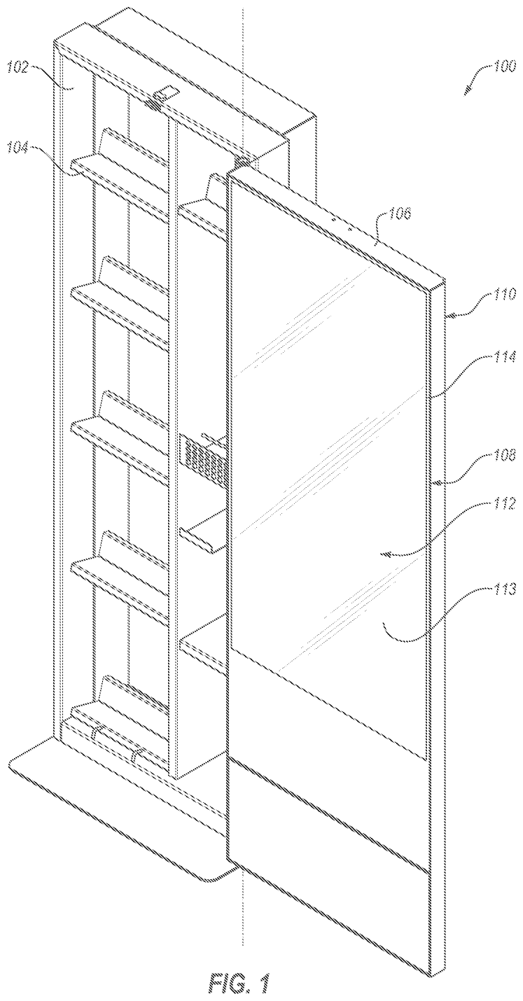

FIG. 1 is a representation of an exercise storage system 100, according to at least one embodiment of the present disclosure. The exercise storage system includes a storage compartment 102. In some embodiments, the storage compartment 102 may include exercise equipment. The exercise equipment may include any piece of exercise equipment. For example, the exercise equipment may include an exercise machine, such as a treadmill, a stationary bicycle, an elliptical machine, a rowing machine, or any other exercise machine. In some embodiments, the exercise machine may include a collapsible or foldable exercise machine, and the exercise machine may fold into the storage compartment. In this manner, the storage compartment 102 may be unobtrusive and/or attractive compact storage for the exercise machine.

As discussed above, the exercise machine may include a collapsible or a foldable treadmill. In some embodiments, the foldable treadmill may include a front end connected to a cable. A support on the cabinet may be connected to a spool connected to the cable. A motor may cause the spool to wind. This may cause the cable to lift the front end of the treadmill deck. In some embodiments, the deck may be lifted while exercising, causing an increase in the incline experienced by the user. In some embodiments, the deck may be lifted into a storage position inside the storage compartment 102. In some embodiments, the treadmill (or any exercise machine) may be completely stored within the storage compartment 102. In other words, a door 106 of the exercise container may completely close an opening of the storage compartment 102, fully containing and removing the treadmill from view.

The storage compartment 102 includes one or more storage elements 104, such as shelves, hooks, and so forth. Any exercise equipment may be placed on the storage elements 104, such as weights, barbells, kettle balls, resistance bands, jump ropes, mats, gloves, clothes, shoes, any other exercise equipment, and combinations thereof.

The exercise storage system 100 includes a door 106. In a closed position (not shown), the door 106 may close over the storage compartment 102 such that the exercise equipment on the storage elements 104 is not visible or physically accessible. In the open position shown, the door 106 may be removed from the opening to the storage compartment 102 such that exercise equipment on the storage elements 104 is visible and accessible to the user.

The door 106 includes an outer face 108 and an inner face 110. In the closed position, the inner face 110 faces the opening of the storage compartment 102 and the outer face 108 faces outward, away from the storage compartment 102. In the open position shown in FIG. 1, the outer face 108 may be oriented to face in a plurality of directions. For example, in the embodiment shown in FIG. 1, the outer face 108 is shown as facing outward, or in the same direction as the opening in the storage compartment 102. Thus, the outer face 108 shown is facing the same direction in the open position as it faced in the closed position.

The outer face 108 of the door 106 includes a display 112. The display 112 includes a mirrored surface 113. The mirrored surface 113 may allow a user to view himself while exercising. This may allow the user to examiner his form while exercising. In this manner, the user may critique and correct his form for exercises, which may help reduce injury, improve muscle strength, improve flexibility, and combinations thereof. Furthermore, because the mirrored surface 113 is located on the door 106, it is conveniently located near the exercise equipment stored in the storage compartment 102 (e.g., on the storage elements 104). This may allow the user to transition between exercises quickly and smoothly, without wasting time by walking from the exercise storage system 100 to a mirror or exercise station.

The display 112 includes a backlit display 114, such as a monitor, a television, or other backlit display. When lit, the backlit display 114 may be visible through the mirrored surface 113. The backlit display 114 may present one or more exercise programs through the mirrored surface 113. The user may follow instructions on the exercise program to perform an exercise. In some embodiments, the exercise program may include instructions regarding the performance of exercises, including exercises using the exercise equipment stored in the exercise storage system 100.

In some embodiments, the backlit display 114 may include a touchscreen display. For example, the user may be able to interact with the backlit display 114 by touching the display 112. The user may provide input to the backlit display 114, respond to queries and other input from the backlit display 114, and otherwise interact with the backlit display 114. In this manner, the user may not need to keep track of a remote or install an application on a mobile device to interact with the display 112 and/or the exercise program shown on the display 112.

In some embodiments, the mirrored surface 113 may be a one-way mirror. In other words, the display 112 may show the backlit display 114 and reflect the user or another image on the mirrored surface 113. In this manner, the user may view herself on the mirrored surface 113 and simultaneously view the backlit display 114. Thus, the user may perform exercises instructed by an exercise program on the backlit display 114, and simultaneously compare her execution of the exercises seen in the mirrored surface to the performance shown on the exercise program. This may improve the user experience, assist the user to improve her exercise form, and allow the user to more effectively perform exercises.

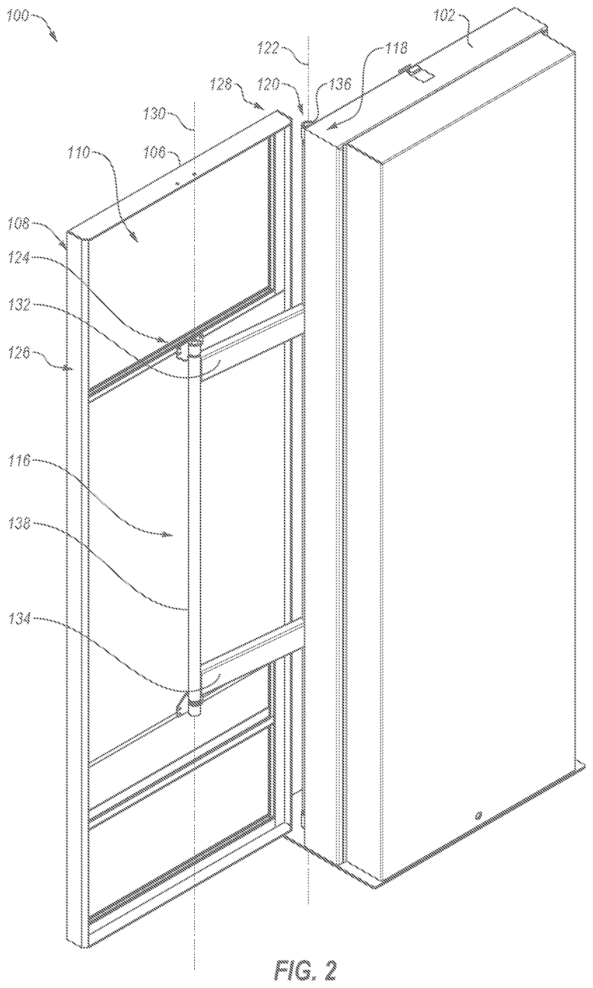

FIG. 2 is a representation of a perspective view of the exercise storage system 100 of FIG. 1, according to at least one embodiment of the present disclosure. In the embodiment shown, the door 106 is connected to the storage compartment 102 with a hinge 116. The hinge 116 may allow the outer face 108 of the door 106 to maintain an adjustable viewing angle. For example, the user may desire for the display (e.g., display 112 of FIG. 1) on the outer face 108 of the door 106 to face the user, even when the door 106 is open. Conventional hinges change the viewing angle of the door 106 by angling the outer face 108 of the door 106 away from the storage compartment 102 when opening. A hinge 116 according to embodiments of the present disclosure may allow the outer face 108 of the door to face the user, even as the door 106 is opened. This may allow the user to access the exercise equipment while facing the display (e.g., the mirrored surface and the backlit display).

In the embodiment shown, the hinge 116 is connected to a first end 118 of the storage compartment 102 with a rotating connection 120. The hinge 116 may rotate about a first axis of rotation 122 at the first end 118 of the storage compartment 102. In some embodiments, the hinge 116 may be connected to the inner face of the door with a rotating connection. The hinge 116 is connected to the inner face 110 of the door 106 at a middle position 124 of the door 106. In other words, the hinge 116 may be connected to the door 106 at a position between a first edge 126 and a second edge 128 of the door 106. The hinge 116 may rotate about a second axis of rotation 130 at the connection to the inner face 110 of the door 106.

In some embodiments, the door 106 may be opened by rotating the hinge 116 about the first axis of rotation 122. This may move the door 106 away from the opening of the storage compartment 102. The viewing angle of the display may be adjusted by rotating the hinge 116 about the second axis of rotation 130. This may change the orientation of the door 106 relative to the user. Thus, the user may orient the door 106 according to her needs and preferences.

In some embodiments, the door 106 may open such that the outer face 108 is facing the same direction as the opening. In other words, the outer face 108 may be parallel to the opening when in an open position, and the outer face may remain pointed in the same direction as in a closed position. As discussed above, this may allow the user to face the display and easily access exercise equipment from the opening, without significantly changing position.

In the embodiment shown, the hinge includes a first lateral member 132 and a second lateral member 134. The first lateral member 132 may be rotatably connected to the storage compartment 102 at the first end 118 and rotatably connected to the door 106 at the inner face 110 of the door 106. The second lateral member 134 may be rotatably connected to the storage compartment 102 at the first end 118 and rotatably connected to the door 106 at the inner face 110 of the door 106. A wall shaft 136 may connect the first lateral member 132 and the second lateral member 134 at the first end 118. A door shaft 138 may connect the first lateral member 132 and the second lateral member 134 at the door 106. In some embodiments, the wall shaft 136 may be rotatably connected to the first end 118, and the door shaft 138 may be rotatably connected to the door 106. In this manner, the hinge 116 may be strong and support a heavy door. In some embodiments, the hinge 116 may include any number of lateral members, such as 1, 2, 3, 4, 5, 6, 7, 8, or more lateral members.

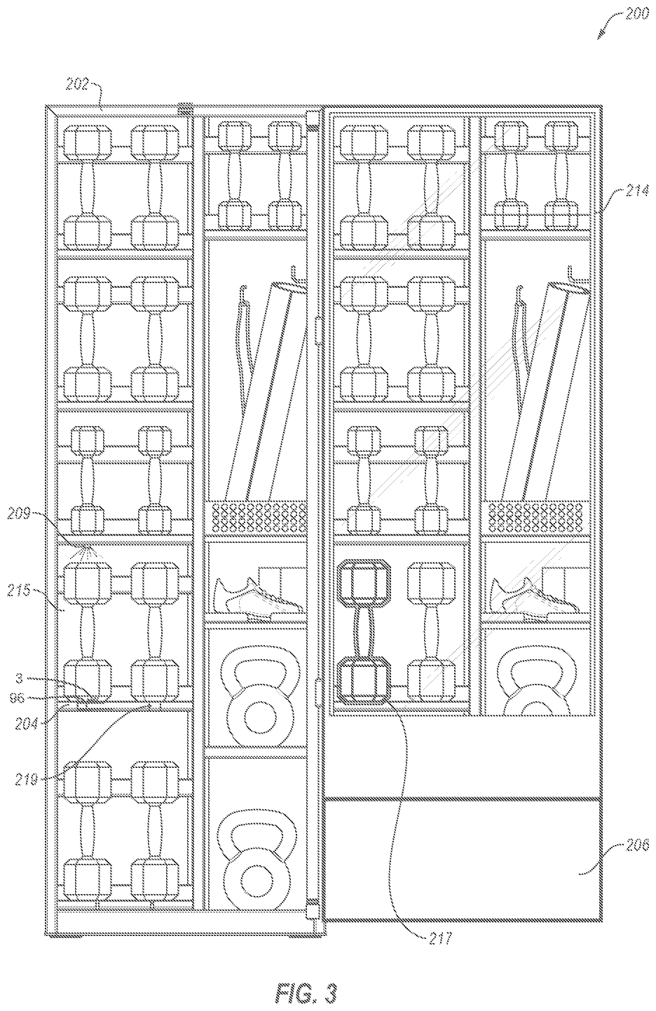

FIG. 3 is a representation of an exercise storage system 200, according to at least one embodiment of the present disclosure. In some embodiments, the storage system may include one or more pieces of exercise equipment, such as dumbbells, shoes, kettle balls, yoga mats, jump ropes, resistance bands, clothes, gloves, towels, exercise machines, any other exercise equipment, and combinations thereof. In the embodiment shown, the backlit display 214 on the door 206 may display a representation of the contents of the storage compartment 202. In some embodiments, the contents of the storage compartment 202 may be schematically shown on the backlit display 214. In some embodiments, a video representation of the contents of the storage compartment 202 may be shown on the backlit display 214. The representation of the contents of the storage compartment 202 may be shown when the door 206 is open or closed. In some embodiments, the representation of the contents of the storage compartment 202 may include a full-size representation of the contents of the storage compartment 202. In this scenario, the representation of the contents of the storage compartment 202 may not include the entirety of the contents, but only that portion visible on the backlit display 214. In some embodiments, the representation of the contents of the storage compartment 202 may include a reduced-size representation of the contents so that the entirety of the contents may be displayed.

In some embodiments, an exercise program may highlight or otherwise emphasize the equipment to be used during an exercise. For example, a portion of the exercise program may use a dumbbell 215. In some embodiments, at the point in the exercise program when the dumbbell 215 is to be used, an indicator light 209 above the desired dumbbell 215 may be lit up. The indicator light 209 may indicate to the user which dumbbell 215 (or other piece of exercise equipment) should be used by the user.

In some embodiments, at the point in the exercise program when the dumbbell 215 is to be used, a representation of the dumbbell to be used may be highlighted 217 on the backlit display 214. For example, the backlit display 214 may highlight the position of the dumbbell to be used. In some examples, the backlit display 214 may highlight the shape of the dumbbell to be used. In some examples, the backlit display 214 may show the entirety of the interior of the storage compartment 202, and the location and dumbbell to be used may be highlighted 217 in the backlit display 214. In some embodiments, a range of dumbbells may be used, depending on the user's fitness level, strength, and fitness goals. Thus, rather than an individual dumbbell or other piece of exercise equipment being highlighted, a location of dumbbells or other pieces of exercise equipment may be highlighted, with the user choosing the individual dumbbell.

In some embodiments, the piece of exercise equipment highlighted 217 may be located on one of the storage elements 204. In some embodiments, the storage elements 204 may include one or more storage sensors 219 configured to determine the presence of the piece of exercise equipment. The storage sensors 219 may include a weight sensor, position sensor, or other location-determining sensor. The storage sensor 219 may determine the presence of the piece of exercise equipment. In some embodiments, when the exercise program highlights the piece of exercise equipment, the exercise program may pause until the user selects the correct piece of exercise equipment after receiving the presence information from the sensor. Similarly, when a specific exercise has been completed, the exercise program may not resume until the piece of exercise equipment has been placed back in the correct location.

In some embodiments, the storage sensor 219 may be any type of sensor. For example, the storage sensor may be a pressure sensor, a distance sensor, a light sensor, a force sensor, an accelerometer, an RFID receiver, any other type of sensor, and combinations thereof.

In some embodiments, the exercise program may instruct the user to utilize any piece of exercise equipment. For example, the exercise program may instruct the user to pick up a dumbbell, deploy a foldable treadmill, retrieve a jump rope, roll out a yoga mat, use any other piece of exercise equipment, or any combination of the foregoing.

While the embodiment of FIG. 3 shows a single indicator light 209 and a single storage sensor 219 for a single piece of equipment, it should be understood that the exercise storage system 200 may include multiple indicator lights 209 and multiple storage sensors 219. For example, each storage element 204 may include a plurality of indicator lights 209 and/or a plurality of storage sensors 219. In some embodiments, each piece of exercise equipment (such as the dumbbells 215, the kettle bells, the shoes, the yoga mats, the jump ropes, and so forth shown in FIG. 3) may be associated with an indicator light 209 and a storage sensor 219 on storage element 204.

In some embodiments, each piece of exercise equipment may have a specific storage location. For example, a dumbbell 215 having a certain weight may have a specific storage location in the exercise storage system 200. The storage sensor 219 may identify the piece of exercise equipment that is placed on or near it. If the piece of exercise equipment placed on or near the sensor is not the specific piece of exercise equipment assigned to that particular location (and storage sensor 219), then a notification may notify the user that the piece of equipment is not installed in the appropriate location. The notification may include an audible notification, a visual notification (e.g., the indicator light 209 highlighting and/or flashing on the piece of equipment), any other notification, and combinations thereof.

In some embodiments, the piece of equipment may include one or more sensors. For example, the piece of equipment may include a tracking sensor 283 that is configured to track the use and/or the location (as disclosed herein with respect to FIG. 10-1 through FIG. 15) of the piece of equipment. The tracking sensor 283 may track motions performed with the piece of equipment, and use those motions to determine a repetition count, track a user's form, direct the location of the backlit display 214, and so forth.

In some embodiments, the storage sensor 219 may be used to determine the presence and/or identity of the piece of equipment. When the piece of equipment is removed from the exercise storage system 200, the identity of the piece of equipment may be communicated to a computing system. In some embodiments, the computing system may determine that the user is performing an exercise activity using the identified piece of equipment based on whether it has been removed from the exercise storage system 200. In some embodiments, when the piece of equipment is placed in the exercise storage system 200, the storage sensor 219 may identify the piece of equipment and the location where it was placed. In this manner, a certain piece of equipment may not need to have a specific location within the exercise storage system 200. In some embodiments, the storage sensor 219 may identify the piece of equipment using any identification mechanism, such an RFID receiver, receipt of a communication, visual identification of a bar or QR code, any other identification mechanism, and combinations thereof.

In some embodiments, when the identified piece of equipment is removed from the exercise storage system 200, the computing system may connect to the tracking sensor 283 on the piece of equipment. For example, when the identified piece of equipment is removed from the exercise storage system 200, the storage sensor 219 may communicate the removal to the computing system. The computing system may then attempt to communicate with the tracking sensor 283 in the identified piece of equipment, and may then receive exercise information from the tracking sensor 283. In some embodiments, the tracking sensor 283 may be dormant, or in a no- or low-powered state. When the piece of equipment is removed from the exercise storage system 200, the storage sensor 219 may instruct the tracking sensor 283 to power up, or to transition to an active state. The tracking sensor 283 may then connect with the computing system to provide exercise and/or location data (as discussed herein with respect to FIG. 10-1 through FIG. 15) to the computing system.

In some embodiments, the tracking sensor 283 on the piece of equipment may be charged in the exercise storage system 200. For example, the storage element 204 may include a charging element 296. The charging element 296 may be configured to align with the tracking sensor 283 and provide charging power to the tracking sensor 283. In some embodiments, the charging element 296 may be a wireless charging system, such as a Qi charging system. In some embodiments, the charging element 296 may be a wired charging system, including contacts on the charging element 296 that align with contacts on the tracking sensor 283.

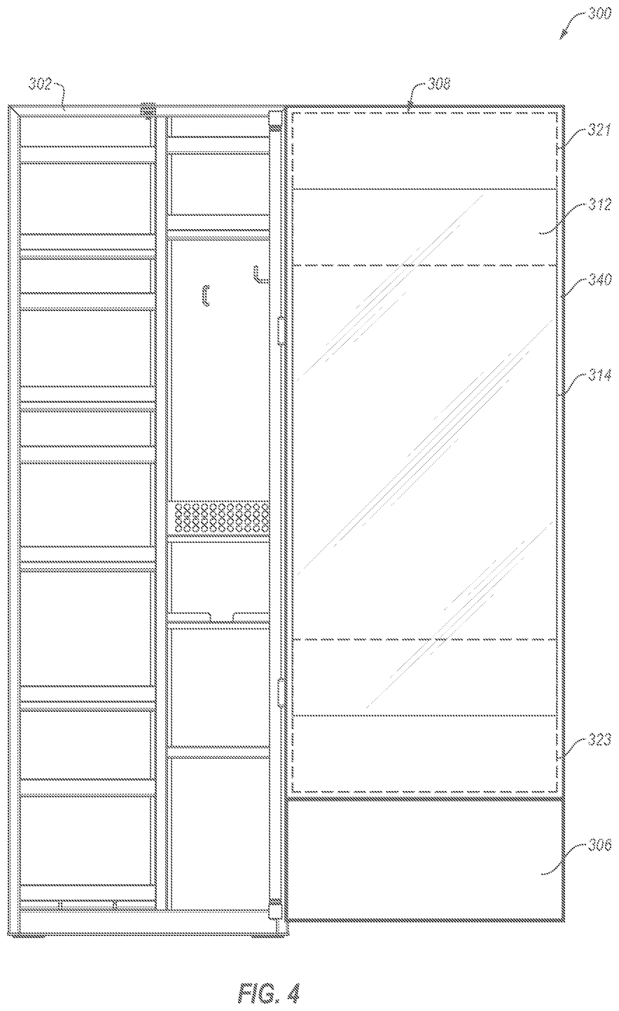

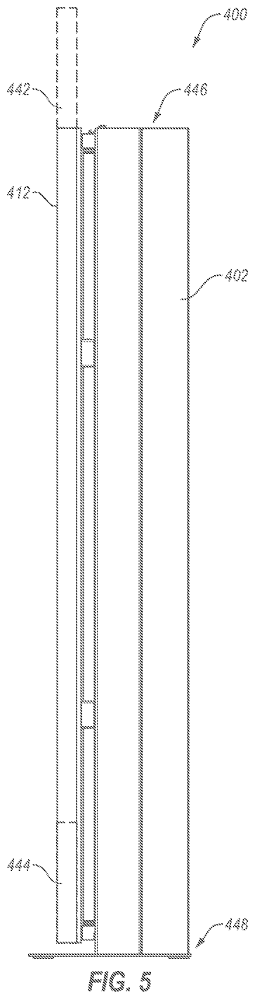

FIG. 4 is a front view of an exercise storage system 300, according to at least one embodiment of the present disclosure. In the embodiment shown, the door 306 is shown in the open position, with the outer face 308 facing the same direction as the opening to the storage compartment 302. The display 312 may be mounted to the outer face 308 of the door 306 with an adjustable connection 340. For example, the display 312 may be mounted to the outer face 308 of the door 306 with a sliding connection 340, and the display 312 may have a vertically adjustable position. For example, the display may be slidably mounted on brackets, and the display 312 may vertically move on the brackets.

In at least one embodiment, a vertically adjustable display 312 may allow the user to customize and/or optimally locate the display 312 for use during an exercise activity. This may allow the user to place the display 312 in a position with a better view and/or to view different portions of his body in the mirrored display during exercise activities. For example, when the user is performing a shoulder press with free weights, the user may wish to have the display 312 located vertically higher to better view himself. In some examples, when the user is performing a yoga move while sitting down, crouching, or resting a portion of his weight on his hands, the user may wish to have the display 312 located vertically lower to better view himself. In some examples, different users may have different heights; a taller user may place the display 312 at a higher position than a shorter user.

In some embodiments, the vertical position of the display 312 may be manually adjustable. In other words, the vertical position of the display may be changed by an application of an upward or a downward force by the user. In some embodiments, a motor may change the vertical position of the display 312. For example, a worm gear, linear motor, hydraulic piston, pneumatic piston, or other electronic and/or electromechanical system may change the vertical position of the display 312.

In the embodiment shown, the backlit display 314 may be movable behind the display 312 (e.g., the mirrored surface). In other words, the backlit display 314 may be movable independent of the rest of the display 312. Thus, the backlit display 314 may be movable between an upper position and a lower position based on the preferences of the user. In some embodiments, the user may choose to move the backlit display 314 to an upper position 321. For example, when doing an elevated exercise, such as a pullup, the user may wish for the backlit display 314 to be raised to the upper position 321. In some embodiments, the user may wish for the backlit display 314 to be in the lower position 323. For example, when doing an exercise near the floor, such as a yoga move, the user may wish for the backlit display 314 to be located near the floor.

FIG. 5 is a side view of the exercise storage system 400, according to at least one embodiment of the present disclosure. In the embodiment shown, the display 412 may be vertically adjustable between an upper position 442 and a lower position 444. As may be seen, in the upper position 442, the display 412 is located above an upper end 446 of the storage compartment 402. In the lower position 444, the display 412 may be located at or proximate a lower end 448 of the storage compartment 402.

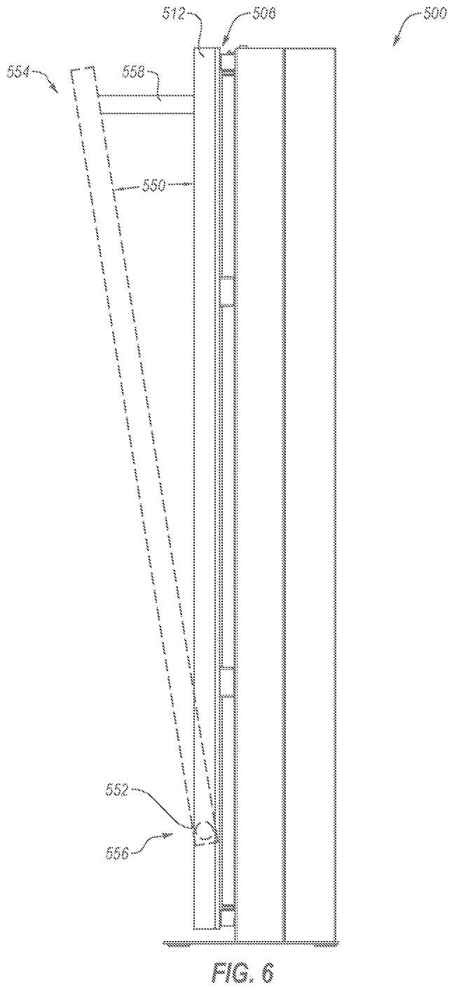

FIG. 6 is a side view of an exercise storage system 500, according to at least one embodiment of the present disclosure. In the embodiment shown, a vertical angle 550 of the display 512 is adjustable. For example, the display 512 may be mounted to the door 506 with a display hinge 552, and the display 512 may be vertically rotated about the display hinge 552. In at least one embodiment, this may allow the user to change the vertical angle 550 of the display 512. In this manner, the user may orient the display 512 as desired. For example, the user may wish to orient the display 512 downward to change the angle with which she may view herself performing a lower activity (e.g., a floor-based activity), and thereby observe and/or critique her form. Similarly, the user may wish to orient the display upward to better view the form of an elevated activity, such as pull-ups or other elevated activity.

In some embodiments, the vertical angle 550 of the display 512 may be manually adjustable. In other words, the vertical angle 550 of the display 512 may be changed by an application of a torque about the display hinge 552 by the user. In some embodiments, a motor may change the vertical angle 550 of the display 512. For example, a motor may rotate the display 512 about the display hinge 552. In some embodiments, the upper portion 554 or the lower portion 556 of the display 512 may be moved linearly to change the vertical angle 550. For example, the upper portion 554 of the display 512 may be moved manually, or with a linear drive 558, such as a worm gear, linear motor, hydraulic piston, pneumatic piston, or other electronic and/or electromechanical system may change the vertical angle 550 of the display.

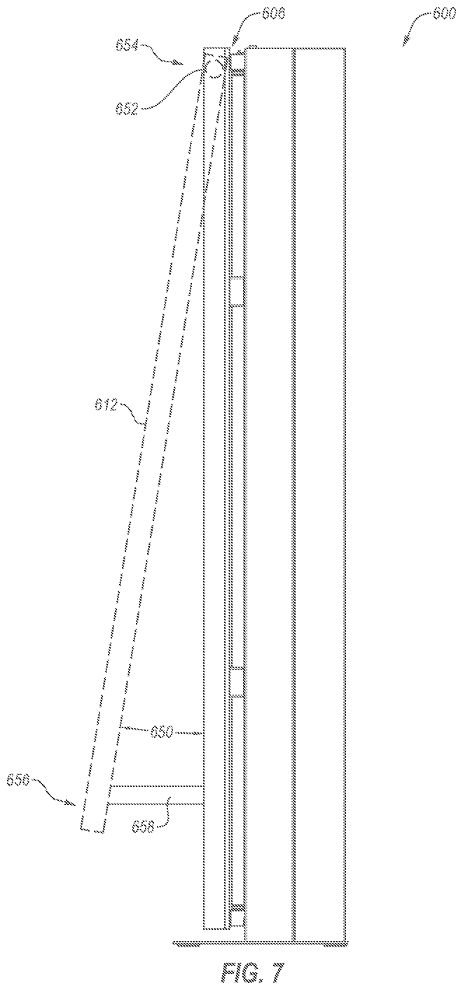

FIG. 7 is a side view of an exercise storage system 600, according to at least one embodiment of the present disclosure. In the embodiment shown, a vertical angle 650 of the display 612 is adjustable. For example, the display 612 may be mounted to the door 606 with a display hinge 652, and the display 612 may be vertically rotated about the display hinge 652. In at least one embodiment, this may allow the user to change the vertical angle 650 of the display 612. In this manner, the user may orient the display 612 as desired. For example, the user may wish to orient the display 612 upward to change the angle with which she may view herself performing a raised activity (e.g., a hanging activity), and thereby observe and/or critique her form.

In some embodiments, the vertical angle 650 of the display 612 may be manually adjustable. In other words, the vertical angle 650 of the display 612 may be changed by an application of a torque about the display hinge 652 by the user. In some embodiments, a motor may change the vertical angle 650 of the display 612. For example, a motor may rotate the display 612 about the display hinge 652. In some embodiments, the upper portion 654 or the lower portion 656 of the display 612 may be moved linearly to change the vertical angle 650. For example, the lower portion 656 of the display 612 may be moved manually, or with a linear drive 658, such as a worm gear, linear motor, hydraulic piston, pneumatic piston, or other electronic and/or electromechanical system may change the vertical angle 650 of the display.

In some embodiments, the hinge (e.g., the hinge 116) may include a linkage that is rotationally connected to the door 606 such that the vertical angle 650 of the door may be adjustable. For example, the hinge may be connected to a center of the door 606, and the entire door 606, rather than just the display 612 is rotated.

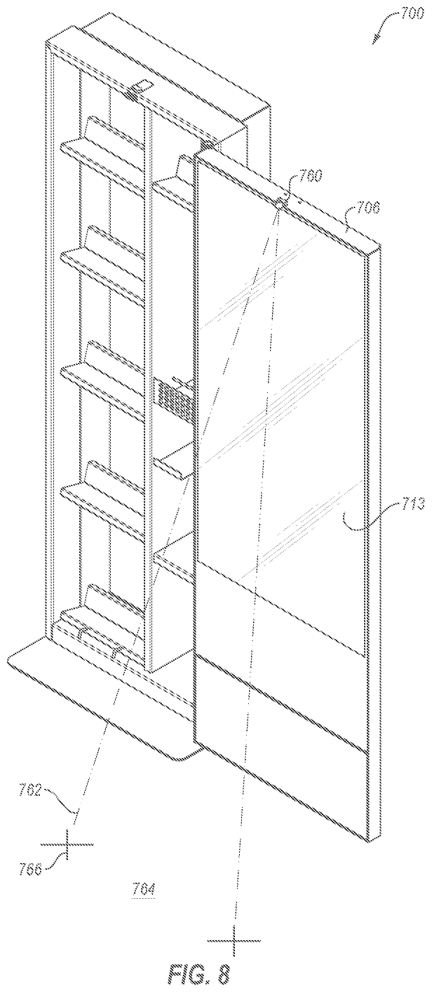

FIG. 8 is a representation of an exercise storage system 700, according to at least one embodiment of the present disclosure. In some embodiments, the exercise storage system 700 may provide guidance for a user. For example, the door 706 may include a light projector 760. The light projector 760 may be located behind the mirrored surface 713, and may project light 762, including visible light, such as a laser or other light, onto a surface 764. The projected light 762 may produce an image on the surface 764 that may assist a user in performing a workout. For example, the projected light 762 may be employed to show a user a location 766 to place their feet, to show a user how far to step or jump, to show a user how to properly position their hips, knees, joints, head, shoulders, or any other body part to properly perform a cable or free weight exercise. In some embodiments, the projected light 762 may project marks that are displayed on the surface 764. In some embodiments, the location 766 may include a projection of the body part to be placed at that location. In some embodiments, as the exercise program progresses, the marks at the location 766 may change shape and/or location, which may indicate to the user to change position, form, change another aspect of the exercise, or any combination thereof. In some embodiments, the surface 764 may include the floor, a wall, a user's body, or any other surface on which the projected light 762 may be transmitted. This may assist a user in performing exercises, which may improve the exercise experience.

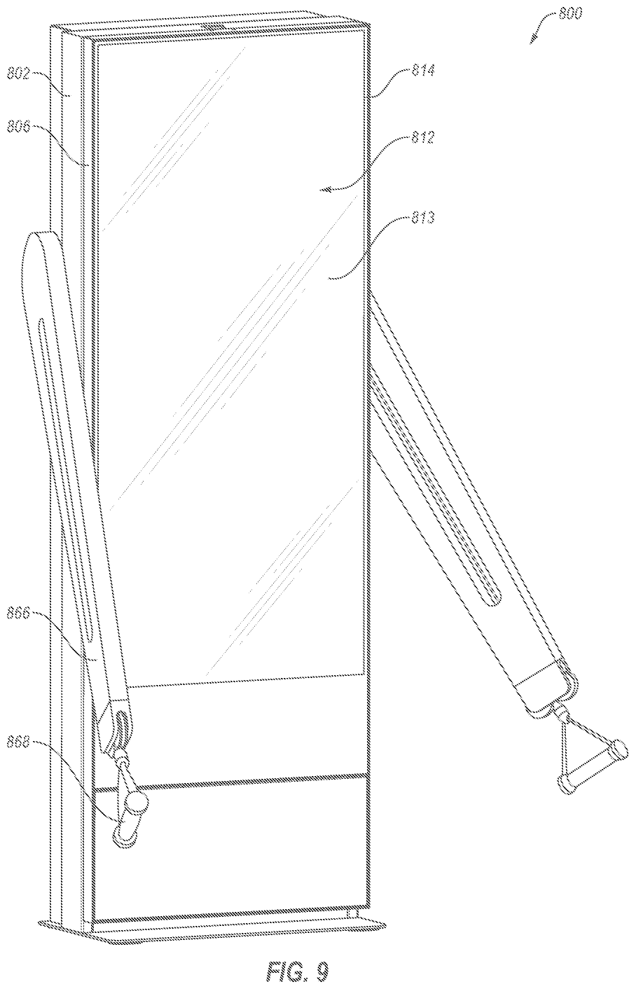

FIG. 9 is a representation of an exercise storage device 800, according to at least one embodiment of the present disclosure. The exercise storage device 800 includes two resistance arms 866. When the door 806 is closed, the user may extend one or both of the resistance arms 866 and perform resistance based exercises. For example, the user may pull on the handles 868, which may be connected to a flywheel within the storage compartment 802. The resistance arms 866 may be rotatable with respect to the storage compartment 802. For example, the resistance arms 866 may be rotated into a storage position, in which the resistance arms 866 are parallel or substantially parallel to the storage compartment. The resistance arms may be further rotatable into different extended positions, which may allow the user to exercise different muscles and muscle groups. Resistance arms and flywheels consistent with the present disclosure are described in U.S. Pat. Nos. 10,188,890 and 10,279,212, the entireties of which are incorporated herein by reference.

The display 812 includes a backlit display 814 that is located behind a mirrored surface 813. The backlit display 814 may display an exercise program. The exercise program may include many exercises, including exercises that may use the resistance arms. The backlit display 814 may further include input features, in which the user may select an exercise program, change a resistance level of the resistance arms 866, and otherwise interact with the exercise program. The backlit display 814 may display any information, including instructions on how to perform an exercise, videos of a trainer or other user performing the exercise, performance statistics, including calories burned, repetitions performed, and so forth, and combinations of the foregoing.

FIG. 10-1 through FIG. 10-3 are representations of an exercise system 1070 with a mirrored display 1072 is various operating positions, according to at least one embodiment of the present disclosure. The mirrored display 1072 may include a display surface 1074. The display surface 1074 may be mirrored, such that an object 1076 presented in front of the mirrored display 1072 may be reproduced on the display surface 1074. The display surface 1074 may further include a backlit display. The backlit display may be displayed behind the mirrored display 1072. The backlit display may present information to the user that the user may view on the display surface 1074. In some embodiments, the display surface 1074 may be both mirrored and include a backlit display, such that the object 1076 may be viewed on the display surface 1074 simultaneously with the backlit display.

In accordance with embodiments of the present disclosure, the mirrored display 1072 may be connected to a support 1078 with a display connection 1080. For example, the support 1078 may be a storage cabinet, as disclosed herein. In some embodiments, the support 1078 may include a wall-mountable bracket that is mounted to the wall. In some embodiments, the support 1078 may be an exercise device, such as a stationary bicycle, an elliptical device, a treadmill, a rower, a cable exercise device, and so forth.

In some embodiments, the display connection 1080 may be a hinge that connects the mirrored display 1072 to the support 1078. In some embodiments, the display connection 1080 may be a rotatable connection, such that the mirrored display 1072 may rotate relative to the support 1078. In some embodiments, the display connection 1080 may be connected to the support 1078 with a support hinge 1081, and the support hinge 1081 may be rotatable. In some embodiments, the display connection 1080 may be connected to the mirrored display 1072 at a display hinge 1082, and the display hinge 1082 may be rotatable. In some embodiments, both the support hinge 1081 and the display hinge 1082 may be rotatable. In the embodiment shown (e.g., in the top-down view shown), the mirrored display 1072 is rotatable about the display hinge 1082 and/or the support hinge 1081, both of which have a rotational axis that is parallel to a force of gravity. As will be seen in FIG. 11-1 and FIG. 11-2, the mirrored display 1072 may be rotatable about a rotational axis that is perpendicular to the force of gravity. In some embodiments, the mirrored display 1072 may be rotatable about a rotational axis that is perpendicular to the force of gravity and about a rotational axis that is parallel to the force of gravity.

In accordance with embodiments of the present disclosure, the mirrored display 1072 may face the object 1076 such that the object 1076 is within a field of view 1084 of the mirrored display 1072. The field of view 1084 may be the area in front of the mirrored display 1072 in which the object 1076 may be clearly viewed in the mirrored display surface 1074, and/or the backlit display on the display surface 1074 can be clearly viewed by a user performing an exercise. For example, the object 1076 may be a user performing an exercise activity. The field of view 1084 may be the area in which the user may see himself perform an activity on the mirrored display 1072 while viewing visual information displayed on the mirrored display 1072. In some embodiments, the object 1076 may be an exercise accessory, and the field of view 1084 may be the area in which the object 1076 may be visible to a user on the mirrored display 1072 and/or detectable by a sensor 1083. In some embodiments, the exercise accessory may include any exercise accessory, such as a ball (e.g., a basketball, a football, a soccer ball, a lacrosse ball, a baseball, a tennis ball, a racquet ball, a squash ball, a cricket ball, a golf ball, a bouncy ball, or any other type of ball), a bat, a weight, a kettle bell, a rope, a jump rope, a pole, a fencing sword, a racquet, any other exercise accessory, and combinations thereof.

In some embodiments, the user may view the mirrored display 1072 along a viewing path 1085, thereby creating a viewing angle 1086 between the mirrored display 1072 and the viewing path 1085. The viewing angle 1086 may be the smallest angle defined by the viewing path 1085 and the display surface 1074. In some embodiments, when the viewing angle 1086 is not a right angle (e.g., when the viewing angle is not) 90°, the viewing angle 1086 may be acute. The viewing angle 1086 may be determined from a viewpoint 1087, which may be a location on the mirrored display 1072. In some embodiments, the viewpoint 1087 may be located in the center of the mirrored display 1072. In some embodiments, the viewpoint 1087 may be located at any point on the mirrored display 1072. For example, the viewpoint 1087 may be located at an outer edge of the mirrored display 1072. In some embodiments, locating the viewpoint 1087 in the center of the mirrored display 1072 may allow the user to move with respect to the mirrored display 1072 while retaining a visible viewing angle, as discussed herein.

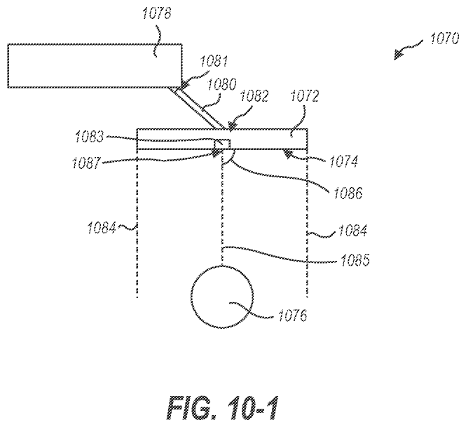

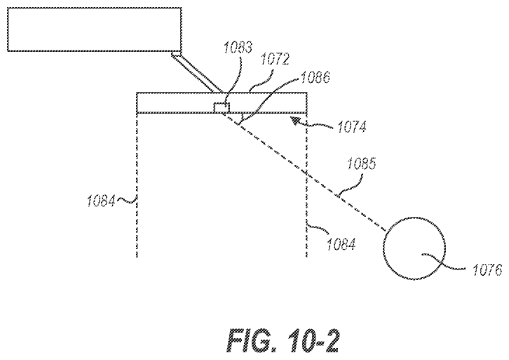

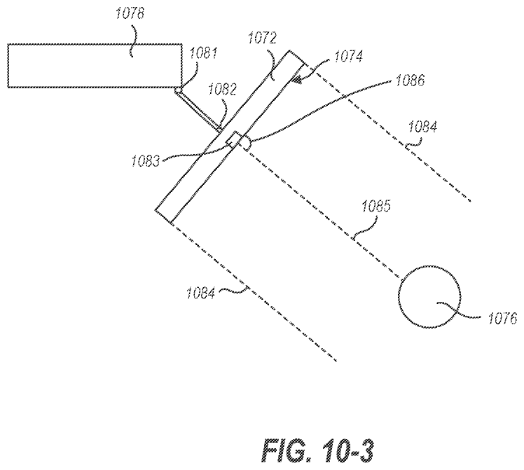

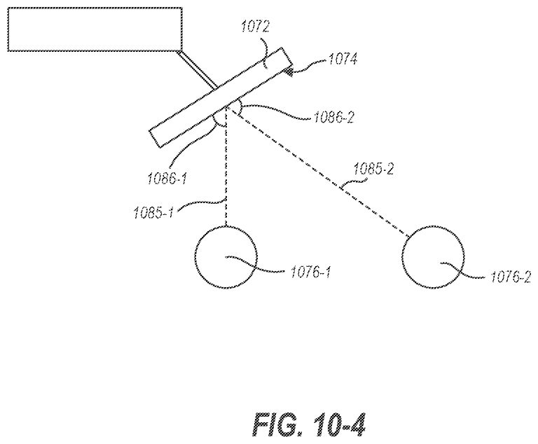

In some embodiments, the information displayed (e.g., the mirrored object 1076 and/or the backlit display) on the display surface 1074 may be visible to the object and/or the user based on the viewing angle 1086. If the viewing angle 1086 becomes too small, such as the viewing angle 1086 seen in the view shown in FIG. 10-2, then the information displayed (e.g., the mirrored object 1076 and/or the backlit display) on the display surface 1074 may not be visible to the user.

In some embodiments, the viewing angle 1086 at which information on the display surface 1074 is visible may be the visible viewing angle. In some embodiments, the visible viewing angle may be in a range having an upper value, a lower value, or upper and lower values including any of 45°, 50°, 55°, 60°, 65°, 70°, 75°, 80°, 85°, 90°, or any value therebetween. For example, the visible viewing angle may be greater than 45°. In another example, the visible viewing angle may be less than 90°. In yet other examples, the visible viewing angle may be any value in a range between 45° and 90°. In some embodiments, it may be critical that the visible viewing angle is greater than 60° to allow the user to view both a reflected image and a backlit image simultaneously on the display surface 1074.

In some embodiments, the mirrored display 1072 and/or the display surface 1074 may have an optimal viewing angle. The optimal viewing angle may be the angle at which the user can see both the object 1076 (e.g., the user and/or the exercise accessory) reflected in the display surface 1074 and the backlit display in the display surface. In some embodiments, the optimal viewing angle may be such that the object 1076 is reflected on top of (e.g., over, overlaid) the backlit display. For example, the object 1076 may be reflected on top of the backlit display to provide the user with a comparison between videos or images in the backlit display and the reflected object. In some embodiments, the optimal viewing angle may be such that the object 1076 is not reflected on top of the display surface 1074, or is not reflected on top of a portion of the display surface 1074. For example, the object 1076 may be reflected to the side of, above, below, or otherwise not on top of information presented in the display surface 1074. This may allow the user to observe without obstruction by the object 1076 the information presented on the display surface 1074 (such as exercise instructions, motivational information, a recreational video, other information, and combinations thereof), while still having a view of the object 1076. In some embodiments, the optimal viewing angle may be a user-defined setting. In some embodiments, the optimal viewing angle may be assigned by the mirrored display 1072 based on an activity being performed.

In some embodiments, the optimal viewing angle may be in a range having an upper value, a lower value, or upper and lower values including any of 45°, 50°, 55°, 60°, 65°, 70°, 75°, 78°, 80°, 82°, 84°, 86°, 88°, 90°, or any value therebetween. For example, the optimal viewing angle may be greater than 45°. In another example, the optimal viewing angle may be less than 90°. In yet other examples, the optimal viewing angle may be any value in a range between 45° and 90°. In some embodiments, it may be critical that the optimal viewing angle is 60° to ensure that all of the visual information presented on the display surface 1074 is visible as intended.

As a user performs exercise activities, the object 1076 (e.g., the user and/or an exercise accessory controlled by the user) may move relative to the mirrored display 1072. This may cause the viewing angle 1086 to change. In some embodiments, the object 1076 may move such that the viewing angle 1086 is reduced to less than the visible viewing angle, as seen in FIG. 10-2. When the viewing angle 1086 is less than the visible viewing angle, the user may not be able to see or may only partially see, the information displayed on the display surface 1074.

In some embodiments, the mirrored display 1072 may determine that the object 1076 has moved if the object 1076 has moved outside of a field of view of the mirrored display 1072 and/or if the object 1076 has moved outside of a field of view of the sensor 1083. The mirrored display 1072 may then be moved in the direction that the object moved before it moved out of the field of view until the object 1076 enters the field of view again.

In some embodiments, the user may perform one or more exercise activities based on a pre-programmed, livestreamed, or otherwise scheduled exercise program. The exercise program may, for example, be scheduled and administered by ICON Health and Fitness' iFit exercise program. Throughout the course of an exercise program, the user may move based on one or more changes in exercise activities and/or based on the movements performed during the exercise. In some embodiments, the movements of the user may be inferred and/or determined based on the scheduled exercise activity. For example, a user may perform a first exercise activity on a stationary bicycle, and the mirrored display may face the user while the user uses the stationary bicycle.

In some embodiments, the exercise program may include any type of exercise activity. For example, the exercise program may include aerobic exercise, such as activities performed on an exercise machine (e.g., a stationary bicycle, a treadmill, an elliptical machine, a rower), dances, aerobics, any other aerobic exercise, and combinations thereof. In some examples, the exercise program may include anaerobic exercise, such as activities performed with a weight machine, a cable exercise device, free weights, body weight exercises (e.g., push-ups, pullups, squats, pull-ups), any other anaerobic exercise, and combinations thereof. In some embodiments, the exercise program may include sports activities, such as basketball exercises, soccer exercises, baseball exercises, golf exercises, any other sport activity, and combinations thereof. In some embodiments, the exercise program may include any other exercise activity, including stretching exercises, yoga, Pilates, plyometrics, cross-fit, power lifting, any other exercise activity, and combinations thereof. In some embodiments, the mirrored display 1072 may be configured to face the user and/or one of the user's exercise accessories while performing an exercise activity. In some embodiments, the exercise program may include any combination of exercise activities discussed herein.

In some embodiments, the exercise program may include a scheduled second exercise activity, such as weight-based exercise (e.g., free-weights, kettle bells, body weight). To perform the second exercise activity, the user dismounts the stationary bicycle and moves away from the stationary bicycle to where the weight-based exercise activity is performed. Based on the scheduled change in exercise activities, the mirrored display 1072 may automatically change position (e.g., without external input from a sensor, without external input from the user) so that it faces the location of the weight-based exercise activity. In some embodiments, the exercise program may include pre-determined positions for the mirrored display for each exercise activity of an exercise program. For example, the exercise program may include a first pre-determined position for the first exercise activity (e.g., in the first pre-determined position, the mirrored display 1072 may face a first location where the user will likely perform the first exercise activity, such as where equipment for the first exercise activity is located). The exercise program may further include a second pre-determined position (e.g., in the second pre-determined position, the mirrored display 1072 may face a second location where the user will likely perform the second exercise activity, such as where equipment for the second exercise activity is located) for the second exercise activity. It should be understood that the exercise program may include any number of pre-determined positions for any number of exercise activities to be performed during an exercise program.

During the first exercise activity of the exercise program, the mirrored display 1072 may be in the first pre-determined position. When the exercise program transitions to the second exercise activity, the mirrored display 1072 may change position to the second pre-determined position. This may occur, for example, while the user is changing positions to transition between the first exercise activity and the second exercise activity. In some embodiments, even if the user does not perform the second exercise activity, the mirrored display 1072 may transition between the first pre-determined position and the second pre-determined position as the pre-programmed exercise program progresses.

After the second exercise activity is completed, the mirrored display 1072 may automatically change position to face the location of the next exercise activity. In this manner, the mirrored display 1072 may continually face the user, regardless of the exercise being performed by the user. This may improve the exercise experience by reducing the need for the user to manually move the mirrored display 1072 and/or provide input to have the mirrored display 1072 move.

In some embodiments, a sensor 1083 on the mirrored display 1072 may sense position information from the object 1076 and the mirrored display 1072 (or a computing system connected to the sensor 1083) may determine the position of the object 1076. The mirrored display 1072 may then determine whether the object 1076 is visible on the display surface 1074. If the mirrored display 1072 determines that the object 1076 is visible on the display surface 1074, then the mirrored display 1072 may perform no action (e.g., the mirrored display 1072 may remain in the same position). If the mirrored display 1072 determines that the object 1076 is not visible on the display surface 1074, then the mirrored display 1072 may change position so that the object 1076 becomes visible on the display surface 1074 (e.g., so that the object moves into the display surface 1074 and becomes visible to the user).

In some embodiments, the mirrored display 1072 may determine that the object 1076 is visible on the display surface 1074 if the viewing angle 1086 is greater than, equal to, or less than the visible viewing angle. If the viewing angle 1086 is greater than or equal to the visible viewing angle, then the mirrored display 1072 may perform no action (e.g., the position and/or angle of the mirrored display 1072 may remain the same). If the viewing angle 1086 is less than the visible viewing angle, then the mirrored display 1072 may change position so that (e.g., until) the object 1076 is visible on the display surface 1074. In some embodiments, the mirrored display 1072 may change positions until the viewing angle 1086 is at an optimal viewing angle.

In some embodiments, the position of the mirrored display 1072 may be changed by rotating the mirrored display 1072 and/or the display connection 1080 to increase the viewing angle 1086 to greater than the visible viewing angle. For example, the mirrored display 1072 may change position by rotating about the display hinge 1082. In some examples, the mirrored display 1072 may change position by rotating about the support hinge 1081 (e.g., the display connection 1080 may rotate about the support hinge 1081, thereby rotating the mirrored display 1072 about the support hinge). In some examples, the mirrored display 1072 may change position by rotating about both the display hinge and the support hinge 1081. In some embodiments, the mirrored display 1072 may change position by translating. For example, the lateral position of the display hinge 1082 relative to the mirrored display 1072 may be changed. In some examples, the lateral position of the support hinge 1081 relative to the support 1078 may be changed. In some embodiments, the lateral position of both the display hinge 1082 and the support hinge 1081 may be changed. In some embodiments, the mirrored display 1072 may change position by both rotating and translating.

In some embodiments, the exercise system 1070 may include one or more display motors connected to the mirrored display. The display motor may cause the mirrored display to change positions. For example, the display motor may be connected to one or both of the support hinge 1081 or the display hinge 1082. The display motor may apply a torque to the mirrored display 1072 about the support hinge 1081 and/or the display hinge 1082, thereby causing the mirrored display 1072 to rotate. In some embodiments, the display motor may cause the mirrored display 1072 to rotate about a rotational axis that is parallel to the force of gravity (e.g., an axis that extends through the support hinge 1081 or the display hinge 1082). In some embodiments, the display motor may cause the mirrored display 1072 to rotate about a rotational axis that is perpendicular to the force of gravity (as may be seen in FIG. 11-1 and FIG. 11-2). In some embodiments, the motor may cause the mirrored display to rotate about a first rotational axis that is parallel to the force of gravity and a second rotational axis that is perpendicular to the force of gravity. In some embodiments, the display motor may include a linear motor that causes the mirrored display 1072 to move the mirrored display laterally and/or vertically.

In some embodiments, the position of the mirrored display 1072 may be changed until the viewing angle 1086 reaches the optimal viewing angle. In some embodiments, the position of the mirrored display 1072 may be changed until the viewing angle reaches a minimum visible viewing angle (e.g., the minimum angle at which the object 1076 may be seen in the display surface 1074 and/or the backlit display is visible on the display surface 1074). In some embodiments, the position of the mirrored display 1072 may be changed until the object 1076 enters the field of view 1084.

In some embodiments, the mirrored display 1072 may track the viewing angle 1086 of an object 1076 relative to a viewer. For example, as may be seen in FIG. 10-4, the mirrored display 1072 may receive position information for a first object 1076-1 and a second object 1076-2. The mirrored display 1072 may determine a position and/or viewing angles 1086 for one or both of the first object 1076-1 and the second object 1076-2. In some embodiments, the first object 1076-1 may be a first user and the second object 1076-2 may be a second user. The first user (e.g., the first object 1076-1) may perform an exercise activity, such as dancing, boxing, wrestling, martial arts sparring, coaching/training, and so forth, with the second user (e.g., the second object 1076-2). During the course of the exercise activity, the second user may move away from the first user. In some embodiments, the mirrored display 1072 may track the second user as the second user moves away from the first user. As the second user moves out of the field of view and/or the viewing angle of the second user reduces to below the visible viewing angle, the mirrored display 1072 may change position such that the second user may be visible and/or view the backlit display of the display surface. In other words, the mirrored display 1072 may prioritize the second user over the first user. Thus, if the second user moves far enough away from the first user, the mirrored display 1072 may change position sufficiently that the first viewing angle 1086-1 is reduced to below a visible viewing angle for the first user. In some embodiments, the mirrored display 1072 may prioritize the first user over the second user. Thus, when the second user moves away from the first user, the mirrored display 1072 may remain fixed on the first user.

In some embodiments, when the second user and the first user move apart from each other, the mirrored display 1072 may change position such that the first user and the second user have the same or similar viewing angles 1086. In other words, the mirrored display 1072 may track the first viewing angle 1086-1 of the first user and the second viewing angle 1086-2 of the second user, and the mirrored display 1072 may change position so that the first viewing angle 1086-1 and the second viewing angle 1086-2 are the same or approximately the same. In this manner, even when the first user and the second user are separated during an exercise activity (either because the users are exercising separately or because the activity causes them to separate), both users may be able to view the information displayed (e.g., their respective reflections and/or the backlit display) on the display surface 1074. While the embodiment of FIG. 10-4 has been shown and described with respect to two users, it should be understood that any number of objects 1076 (e.g., users and/or exercise accessories) may be used with the mirrored display 1072. For example, the mirrored display 1072 may change position so that three, four, five, six, or more users may see the information displayed on the display surface.

In some embodiments, the first object 1076-1 may be a user and the second object 1076-2 may be an exercise accessory. In some embodiments, the user may utilize the exercise accessory and the exercise accessory may move away from the user. For example, a user may be performing sports drills (e.g., dribbling exercises) that cause the exercise accessory to move away from the user. In some embodiments, the mirrored display 1072 may stay facing the user while the exercise accessory moves away from the user. In some embodiments, the mirrored display 1072 may change position to keep the exercise accessory in view of the mirrored display 1072. In some embodiments, the mirrored display 1072 may change position so that the user may still see herself and the exercise accessory in the display surface 1074 as the exercise accessory moves away from the user.

In some embodiments, the mirrored display 1072 may change positions to face the object 1076 using a combination of both pre-determined positions and sensed locations of the object 1076. For example, the mirrored display 1072 may transition between a first pre-determined position and a second pre-determined position based on a transition between exercise activities. After the mirrored display has moved to the second pre-determined position, the sensor 1083 may sense the location of the user, and the mirrored display 1072 may make small adjustments to its position based on the exact location of the user. For example, the sensor 1083 may track the reflected light from the user's iris to determine the user's viewing path 1085 and the viewing angle 1086. Based on the determined viewing path 1085 and viewing angle 1086, the mirrored display 1072 may fine-tune its position to optimize the viewing experience for the user. By automatically moving into the second pre-determined position, the mirrored display 1072 may prevent losing track of the object 1076 if the object 1076 moves faster than the sensor 1083 can track it (e.g., the object 1076 may move out of the sensing range of the sensor 1083 before the sensor can adjust). This may improve the exercise experience by ensuring that the mirrored display 1072 is always facing the user during exercise activities.

In some embodiments, the position of the mirrored display 1072 may be determined based on a piece of exercise equipment that is selected by the user. For example, as may be seen in FIG. 3, a use storage sensor 219 may be associated with each piece of exercise equipment. The mirrored display 1072 may be in communication with the use storage sensor 219 for each piece of exercise equipment. When a user picks up a piece of exercise equipment, the use storage sensor 219 may communicate which piece of exercise equipment the user picked up. Based on the selected exercise equipment and/or the place in the exercise program, the mirrored display 1072 may infer an exercise activity that is being performed and/or a location for the activity to be performed.

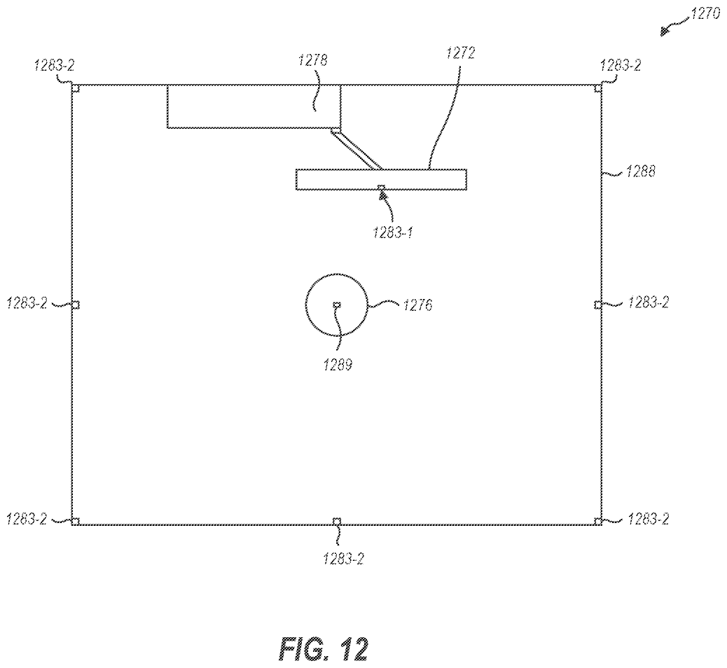

In some embodiments, the exercise equipment may include a sensor. When the piece of exercise equipment is selected by the user and removed from the exercise storage system 200, the use storage sensor 219 may cause a sensor (such as the receptor of FIG. 12) to be activated. In this manner, the mirrored display 1072 may be able to track activities being performed by the user and/or which equipment the user is using.

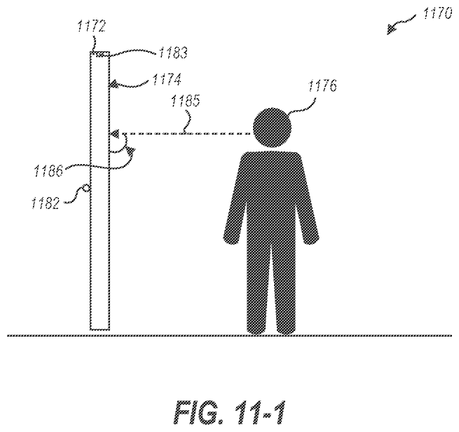

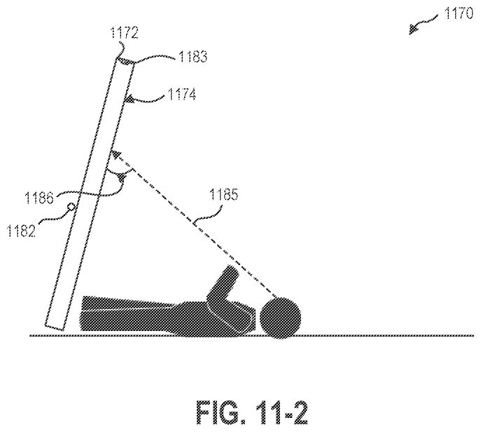

FIG. 11-1 and FIG. 11-2 are representations of a side-view of an exercise system 1170 including an adjustable mirrored display 1172, according to embodiments of the present disclosure. In the embodiment shown in FIG. 11-1, an object 1176 (e.g., a user) may be performing an exercise activity in front of the mirrored display 1172. The mirrored display 1172 may be located in a first position and the user may be able to view information displayed on a display surface 1174 of the mirrored display 1172. For example, the display surface 1174 may display information from a backlit surface and/or present a reflected image of the object 1176.

In some embodiments, the mirrored display 1172 may detect a viewing angle 1186 of the object 1176. The viewing angle 1186 may be the angle at which the object 1176 views information on the display surface 1174 across the viewing path 1185. In the embodiment shown, the user is performing an exercise activity in an upright position, and the mirrored display 1172 is positioned such that the user can view the information displayed on the display surface 1174.

In some embodiments, an exercise activity may cause the user to change vertical position. For example, as may be seen in FIG. 11-2, the user may perform an exercise on the ground, such as a yoga activity, a stretch, a mindfulness activity, and so forth. The mirrored display 1172 may detect the position of the user and/or the viewing angle 1186 generated by the viewing path 1185 and the mirrored display 1172. In some embodiments, based on the viewing angle 1186, the mirrored display 1172 may change position to increase the viewing angle 1186 to a visible viewing angle. In some embodiments, the mirrored display 1172 may rotate about a display hinge 1182 with a rotational axis that is perpendicular to the force of gravity to change the viewing angle 1186. In some embodiments, the mirrored display 1172 may translate vertically to change the viewing angle 1186.

In some embodiments, the mirrored display 1172 may include a motion sensor 1183. The motion sensor 1183 may capture motion information about a user (e.g., the object 1176). In some embodiments, while the user is performing an exercise activity, the motion sensor 1183 may capture information related to the exercise activity. For example, the user may be performing an exercise activity that utilizes a specific body posture (e.g., form). The motion sensor 1183 may capture the form of the user, including relative positioning, angles, and orientations of the user's limbs, torso, head, hands, feed, exercise accessories, and combinations thereof.

In some embodiments, the mirrored display 1172 may display the information on the display surface 1174. For example, the mirrored display 1172 may present a skeleton or schematic view of the user performing an exercise next to or overlaid over an example of the “proper” form, or the body position of the exercise activity that may promote a specific muscle strengthening and/or prevent injury. In some embodiments, the example may be in the form of a trainer or other video of a person performing the exercise activity. In some embodiments, the example may be in the form of a schematic or cartoon image of a person performing the exercise activity.

In some embodiments, the motion sensor 1183 may only capture motion of the user, without capturing video images of the user. This may help to provide the user of his or her privacy while utilizing the exercise system 1170.

FIG. 12 is a representation of an exercise system 1270 with a mirrored display 1272 installed on the wall of a room 1288, according to at least one embodiment of the present disclosure. An object 1276 (such as a user and/or an exercise accessory) may perform an exercise activity inside the room 1288. One or more sensors (collectively 1283) may track the object 1276 as it moves about the room during the exercise activity. When the object 1276 moves away from the mirrored display, the sensor 1283 may communicate the position to the mirrored display 1272, and the mirrored display 1272 may change position to face the object 1276.

In some embodiments, a display sensor 1283-1 may be located on the mirrored display 1272. In this manner, the display sensor 1283-1 may easily sense and determine the position of the object 1276 relative to the mirrored display 1272. In some embodiments, a sensor 1283 may be located remotely from the mirrored display 1272. For example, one or more room sensors 1283-2 may be located within the room 1288. The room sensors 1283-2 may communicate the position of the object 1276 to the mirrored display 1272. In some embodiments, utilizing a room sensor 1283-2 may help to determine the absolute location of the object 1276 within the room 1288. In some embodiments, a plurality of room sensors 1283-2 may triangulate the position of the object 1276 within the room. In some embodiments, the exercise system 1270 may include a display sensor 1283-1 and one or more room sensors 1283-2.

In some embodiments, one or more of the room sensors 1283-2 may be located outside of a field of view of the mirrored display 1272. Thus, in some embodiments, the mirrored display 1272 may receive position information about the object 1276 from a room sensor 1283-2 located outside of a field of view of the mirrored display 1272. In some embodiments, one or more of the room sensors 1283-2 may be located outside of the field of view (e.g., the sensing area) of the display sensor 1283-1. Thus, in some embodiments, the mirrored display 1272 may receive position information about the object 1276 from a room sensor 1283-2 that is located outside of a field of view of the display sensor.

While embodiments of the present disclosure have discussed a display sensor 1283-1 located on the mirrored display 1272, it should be understood that the display sensor 1283-1 may be located anywhere else in the exercise system, such as on the support 1278. In some embodiments, the display sensor 1283-1 may be integrally formed with the mirrored display 1272. In some embodiments, the display sensor 1283-1 may be separately formed and placed on the mirrored display 1272. For example, the display sensor 1283-1 may be placed the top of the mirrored display 1272 and/or adhered (e.g., magnetically, with one or more suction cups, with an adhesive) to the mirrored display 1272.

Similarly, while the room sensors 1283-2 have been described as being located on the walls of the room 1288, it should be understood that the room sensors 1283-2 may be located in any remote location from the mirrored display 1272. For example, the room sensors 1283-2 may be located on the ceiling, on the floor, on a table, on a stand, suspended from the ceiling, or any other location within the room 1288. In some embodiments, the room sensors 1283-2 may be dedicated to the exercise system. In some embodiments, the room sensors 1283-2 may be present in the room when the exercise system 1270 is installed, such as security cameras.

In some embodiments, the sensor 1283 may be any type of sensor. For example, the sensor 1283 may be a camera, a motion sensor, a distance sensor, a LIDAR sensor, any other type of sensor, and combinations thereof. In some embodiments, the sensor 1283 may be a facial tracking sensor 283 that tracks where a user's face is located. In some embodiments, the sensor 1283 may track reflected light from a user's eyes (e.g., the iris). In some embodiments, the sensor 1283 may be optimized to track wavelengths of light that reflect well from the user's iris.

In some embodiments, the object 1276 may include a tracking device. For example, the object 1276 may include a receiver 1289, such as a radio frequency identification (RFID) receiver, motion-capture sensors, infrared receivers, and so forth. The sensor 1283 may ping and receive responses from the receiver 1289 to determine the location of the object 1276 relative to the sensor 1283 and/or the mirrored display 1272. In some embodiments, the object 1276 may include other motion-capture sensors and/or receivers 1289 that may communicate the motions of the object 1276 to the mirrored display 1272 and/or the sensors 1283. In some embodiments, the object may include a receiver 1289 that includes one or more motion sensors, such as one or more of accelerometers, force sensors, torque sensors, and so forth. The receiver 1289 may use dead reckoning (e.g., incremental changes in position added together to determine a net change in position over time) to determine the position of the object 1276. The receiver 1289 may then communicate the position information to the mirrored display 1272. In some embodiments, the user and/or the receiver 1289 may identify a starting position for the object 1276 and use dead reckoning to determine changes in position to the object 1276.

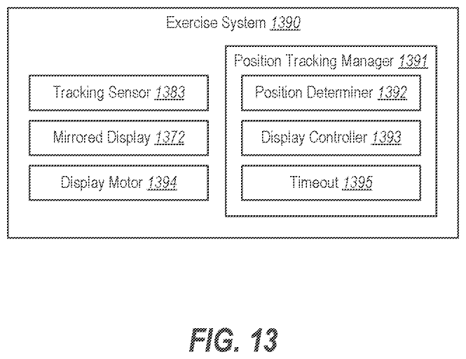

FIG. 13 is a representation of an exercise system 1390, according to at least one embodiment of the present disclosure. The exercise system 1390 may include a position tracking manager 1391. The position tracking manager 1391 may be in communication with a tracking sensor 1383. The tracking sensor 1383 may be any position sensor, motion sensor, a receiver on an object, any other sensor discussed herein, any other senor, and combinations thereof. In some embodiments, the position tracking manager 1391 may receive position information from the tracking sensor 1383. The position tracking manager 1391 may include a position determiner 1392. The position determiner 1392 may utilize the position information received from the tracking sensor 1383 to determine the position of the object (e.g., the user and/or an exercise accessory). In some embodiments, the position determiner 1392 may determine the position of the object relative to a mirrored display 1372. In some embodiments, the position determiner 1392 may determine the absolute position of the object in a room or other exercise area.

The position tracking manager 1391 includes a display controller 1393. Based on the determined position, the display controller 1393 may control one or more display motors 1394 connected to the mirrored display 1372. The display motor 1394 may control a position of the mirrored display 1372. For example, the display motor 1394 may control a rotational position, a lateral position, a vertical position, or combinations thereof, of the mirrored display 1372. In some embodiments, the display controller 1393 may cause the mirrored display 1372 to change positions to face the tracked object such that the tracked object is visible in the mirrored display.

In some embodiments, the position tracking manager 1391 may include a timeout 1395. The timeout 1395 may be used to determine whether the object is moving too fast to be effectively tracked. For example, a user may be performing an exercise activity that involves fast lateral movements that take him or her in and out of the field of view of the mirrored display 1372. In some embodiments, the display controller 1393 and/or the display motor 1394 may not be able change position of the mirrored display 1172 fast enough to track the user. In some embodiments, such fast movements of the mirrored display 1372 my cause undue wear and tear on the mirrored display 1372, the display motor 1394, the hinge or support supporting the mirrored display 1372, or combinations thereof. Furthermore, when performing a high-movement activity, the user may not focus on the mirrored display 1372.

To prevent the mirrored display 1372 from moving around too much, the display controller 1393 may consult a timeout 1395 to determine if the object has stayed in one position for a timeout period, such as 1 s, 2 s, 3, s, 4, s, 5, s, 10 s, 15 s, 20 s, 25 s, 30 s, or any value therebetween. If the object has stayed in one position for the timeout period, then the display controller 1393 may cause the display motor 1394 to move the mirrored display 1372 to face the object. In some embodiments, the display controller 1393 may determine that the object has stayed in one position if the object does not move a timeout distance during the timeout period. For example, the timeout distance may be 1 in., 2 in., 3 in., 4 in., 5 in., 6 in., 9 in. 12 in., 18 in, 24 in., or any value thereof. It should be understood that any combination of timeout distances and/or timeout periods may be combined to determine whether mirrored display 1372 will be moved to face the user.

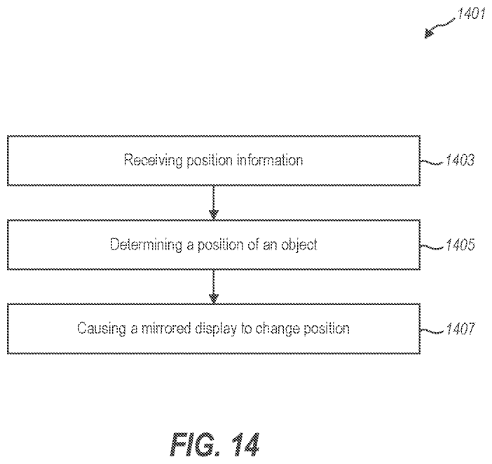

FIG. 14 is a representation of a method 1401 for exercise tracking, according to at least one embodiment of the present disclosure. The method 1401 may be implemented by and/or with the exercise systems of FIG. 10-1 through FIG. 13. The method 1401 includes receiving position information of an object at 1403. The position information may be received from a tracking sensor, from a receiver on the object, from an exercise program, from any other source, and combinations thereof. In some embodiments, using the position information, the position of the object relative to a mirrored display may be determined at 1405. Based on the determined position of the object, the mirrored display may be caused to change position at 1407.

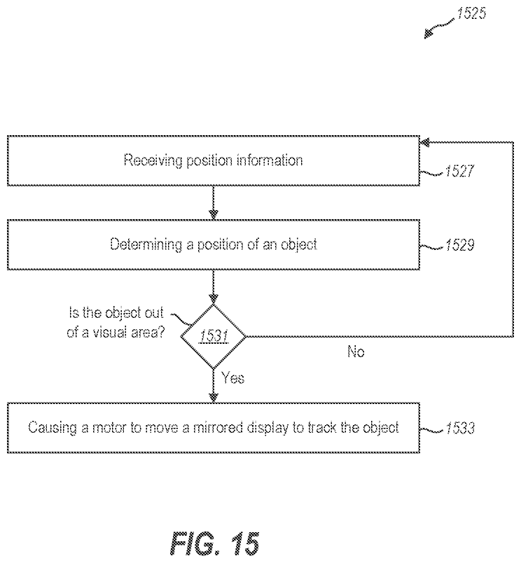

FIG. 15 is a representation of a method 1525 for exercise tracking, according to at least one embodiment of the present disclosure. The method 1525 may include receiving position information for an object at 1527 and determining a position of the object at 1529. In some embodiments, the method 1525 may include determining 1531 whether the object is outside of a visual area of a mirrored display. For example, the method may include determining whether the viewing angle of the object (e.g., a user) to the mirrored display is greater than a visual angle. If the object is not outside of the visual area of the mirrored display, then the method may loop back to receiving the position information. If the object is outside of the visual area of the mirrored display, then the method may cause a motor to move the mirrored display to track the object at 1533.

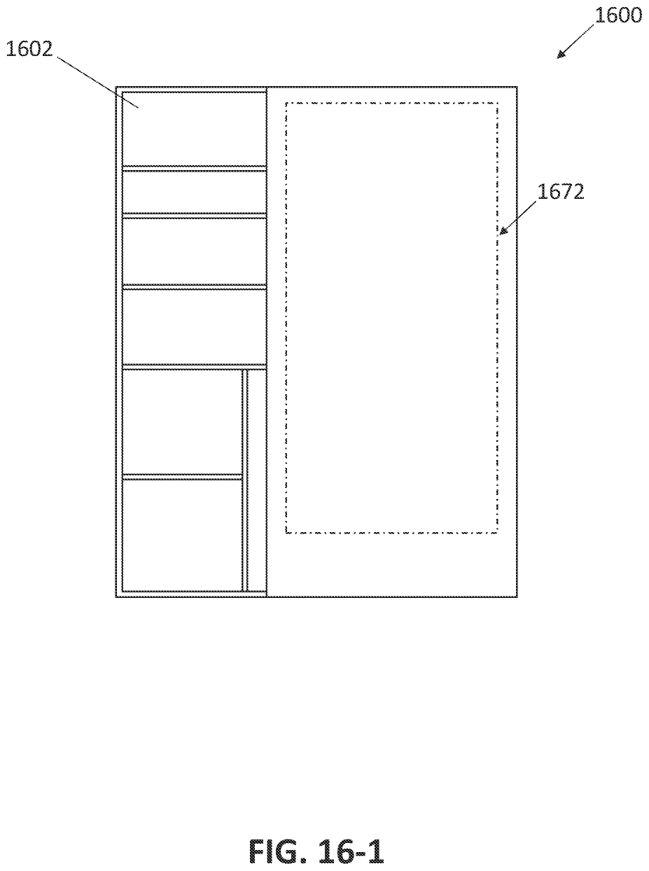

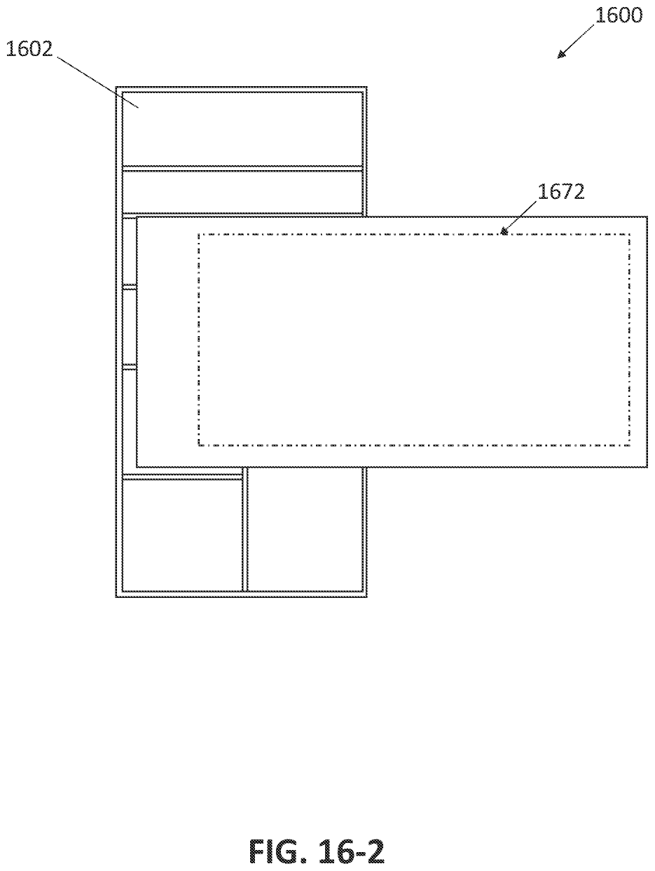

FIG. 16-1 is a representation of an exercise storage system 1600, according to at least one embodiment of the present disclosure. The exercise storage system 1600 includes a storage compartment 1602. A mirrored display 1672 is connected to the storage compartment 1602. The mirrored display 1672 may include a mirrored surface that reflects a large amount of light. When a user is performing an exercise in front of the mirrored display 1672, the user may be reflected in the mirrored display 1672. The mirrored display 1672 may further include a backlit display. The backlit display may allow the user to view content on the mirrored display 1672 while performing an exercise. Because the mirrored display 1672 is both highly reflective and includes a backlit display, a user may be able to use the mirrored display 1672 to simultaneously receive instruction from the backlit display and compare his or her form in the reflective surface.

As discussed herein, the mirrored display 1672, may be connected to the storage compartment 1602 with a hinge. The hinge may be connected to a motor. The motor may cause the mirrored display 1672 to change position. In some embodiments, as may be seen in FIG. 16-2, the motor may cause the mirrored display 1672 to rotate 90°. The mirrored display 1672 shown may be in the “portrait” orientation in FIG. 16-1. In the portrait orientation, the height of the mirrored display 1672 may be greater than the width, where the height of the mirrored display is measured parallel to the force of gravity. The motor may rotate the mirrored display 1672 about an axis transverse (e.g., not parallel) or perpendicular to the force of gravity. In some embodiments, the motor may rotate the mirrored display 1672 about an axis that is perpendicular to the plane of the mirrored display 1672.

As may be seen in FIG. 16-2, the mirrored display 1672 has rotated into the “landscape” orientation. In the landscape orientation, the width of the mirrored display 1672 may be larger than the height of the mirrored display, where width is measured perpendicular to the force of gravity. Changing orientations of the mirrored display 1672 may allow for different viewing configurations for the user. Some exercise activities and/or exercise programs may utilize video or other media that is oriented in the landscape orientation. Indeed, a user may desire to check his or her form for some exercise activities in the landscape orientation. For example, in many body weight exercises the user's body is oriented parallel to the force of gravity, such as during a pushup. In the landscape orientation shown in FIG. 16-2, more of the user's body may be visible in the landscape orientation, thereby allowing the user to more closely analyze his or her form. In some embodiments, a user may utilize an exercise device that may benefit from the landscape orientation. For example, in a rower, the user's body and motions may be more fully visible and/or larger in the landscape orientation. This may allow the user to inspect and correct his or her form while remaining in the mirrored display 1672, without the mirrored display 1672 moving to keep the user in view. This may help to improve the user experience.

While the mirrored display 1672 is connected to a storage device 1602 in the embodiments shown, it should be understood that the mirrored display 1672 may be connected to any exercise device. For example, the mirrored display 1672 may be connected to a treadmill, an elliptical machine, a rower, a cable strength exercise device, any other exercise device, and combinations thereof. In some embodiments, the mirrored display 1672 may not be connected to an exercise device. For example, the mirrored display may be connected to a wall, to the floor, suspended from the ceiling, freely supported on its own structure, and combinations thereof. This may allow the mirrored display 1672 to be used with any exercise device and with multiple exercise devices.

FIG. 17-1 through FIG. 17-3 are representations of an exercise system 1700 having a split mirrored display (collectively 1772), according to at least one embodiment of the present disclosure. The split mirrored display 1772 includes a first portion 1772-1 and a second portion 1772-2. The first portion 1772-1 and the second portion 1772-2 may be independently movable. Put another way, the first portion 1772-1 may be independently movable from the second portion 1772-2. The first portion 1772-1 may be connected to a storage system 1702 with a first motor and the second portion 1772-2 may be connected to the storage system 1702 with a second motor. The first motor and the second motor may be independent, and may move their respective portions independently.

In some embodiments, the first portion 1772-1 and the second portion 1772-2 may be configured as a coordinated display to display coordinated content. Coordinated content may include content that is displayed over both the first portion 1772-1 and the second portion 1772-2. For example, coordinated content may include a picture or a video that is continuous across a break between the first portion 1772-1 and the second portion 1772-2. In this manner, the first portion 1772-1 and the second portion 1772-2 may combine to form a combined display that can display larger or more content than either the first portion 1772-1 or the second portion 1772-2 individually.

In some embodiments, the first portion 1772-1 and the second portion 1772-2 may be configured to simultaneously (e.g., at the same time) display independent content. For example, the first portion 1772-1 may display a first image or video and the second portion 1772-2 may display a second image or video. This may allow a group of users to exercise together in different locations in the same room, work on different exercises simultaneously, work at different exercise stations, and so forth. In some embodiments, different independent content on the first portion 1772-1 and the second portion 1772-2 may allow the user to move between exercise stations at different locations in an exercise room without one or both of the first portion 1772-1 or the second portion 1772-2 moving.

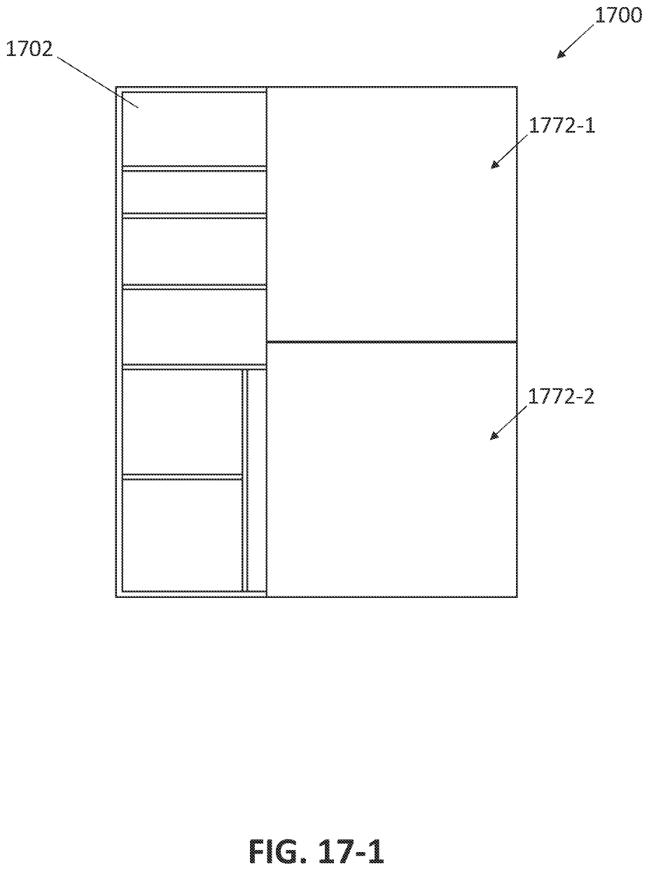

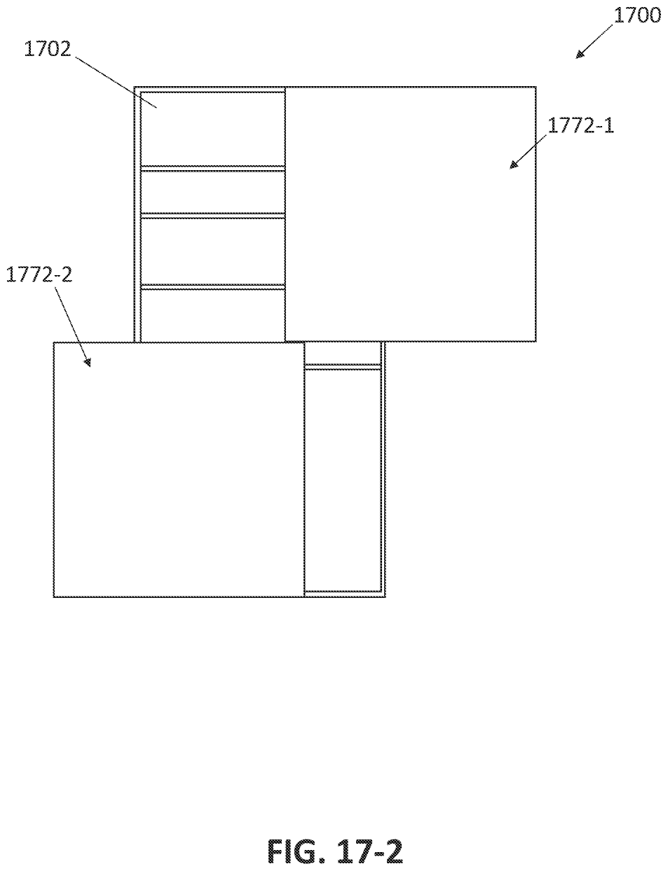

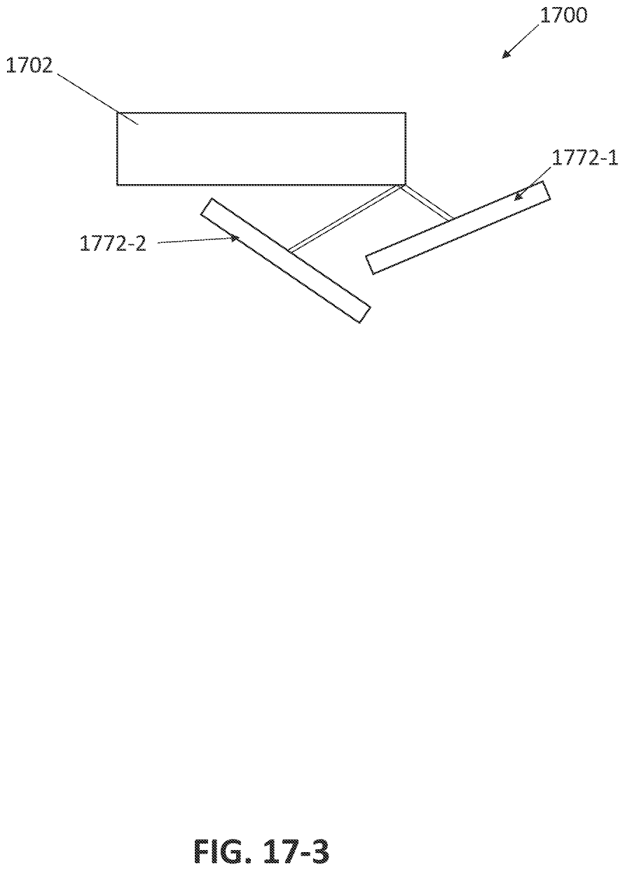

As may be seen in FIG. 17-2, the first portion 1772-1 may be independently movable (e.g., translatable in one or more of the x-, y-, or z-directions and/or rotatable about one or more of the x-, y-, or z-axis) from the second portion 1772-2. For example, in the embodiment shown, the second portion 1772-2 has been laterally moved from the position shown in FIG. 17-1 to the position shown in FIG. 17-2. This may allow the user to quickly change position and retain a functional viewing angle of one or both of the first portion 1772-1 or the second portion 1772-2 without either of them moving.

While the second portion 1772-2 is shown as moving laterally from the position shown in FIG. 17-1 to the position shown in FIG. 17-2, it should be understood that the first portion 1772-1 and/or the second portion 1772-2 may be moved ((e.g., translatable in one or more of the x-, y-, or z-directions and/or rotatable about one or more of the x-, y-, or z-axis)) in any direction discussed herein. For example, the first portion 1772-1 and/or the second portion 1772-2 may be moved vertically (e.g., parallel to a force of gravity), rotated about an axis parallel to the force of gravity, rotated about an axis perpendicular to the force of gravity and parallel to the plane of the first portion 1772-1 and/or the second portion 1772-2, rotated about an axis perpendicular to the force of gravity and perpendicular to the plane of the first portion 1772-1 and/or the second portion 1772-2, moved in any other direction, and combinations thereof. In this manner, the first portion 1772-1 and/or the second portion 1772-2 may be oriented to face the user in a variety of different locations, orientations, and positions.

FIG. 17-3 is a top-down view of the exercise system 1700 of FIG. 17-1 and FIG. 17-2, according to at least one embodiment of the present disclosure. As may be seen, the first portion 1772-1 and the second portion 1772-2 may be independently moved and oriented at different orientations. For example, the first portion 1772-1 and the second portion 1772-2 have different angular orientations relative to the storage compartment 1702. This may allow a first user to exercise in front of the first portion 1772-1 and a second user to exercise in front of the second portion 1772-2, and for both users to see their individual reflection in their respective mirrored surface. Exercising with friends or other people is often more enjoyable, and this may improve the exercise experience.

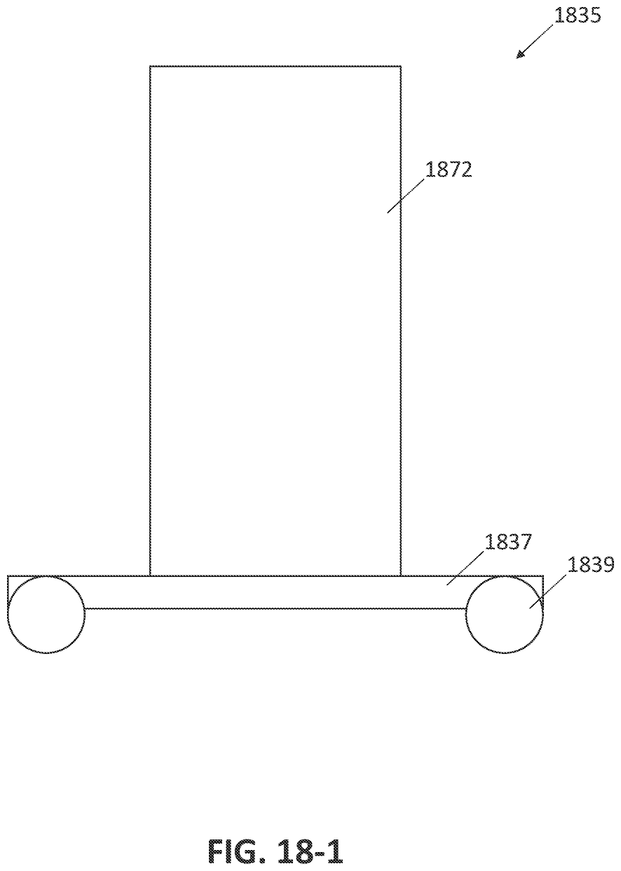

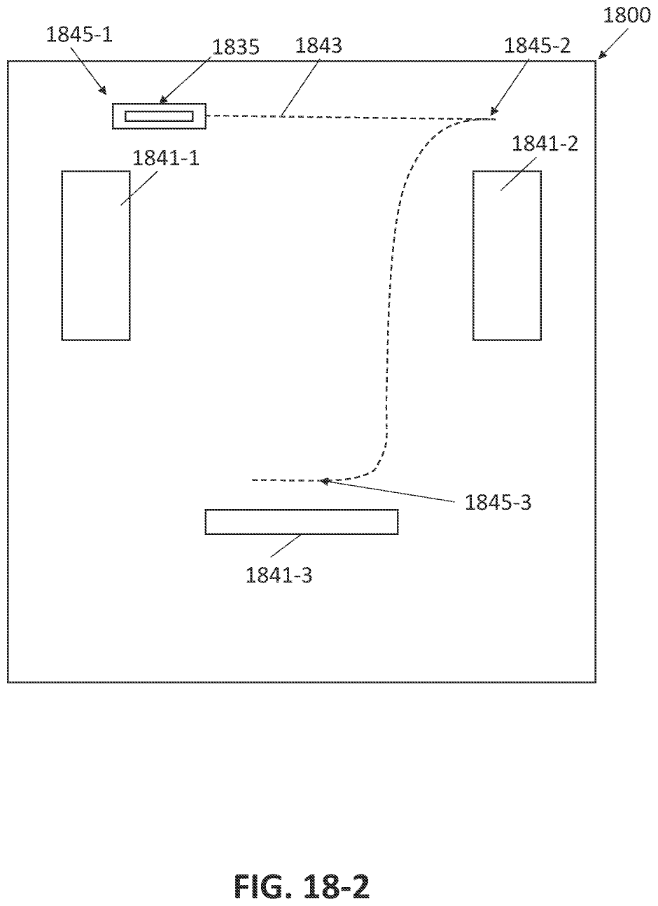

FIG. 18-1 is a representation of a mobile display 1835, according to at least one embodiment of the present disclosure. The mobile display 1835 may include a mirrored display 1872 mounted to a cart 1837. The mirrored display 1872 may be any mirrored display discussed herein. The cart 1837 may be a wheeled cart that includes at least one wheel 1839 or other motive element. The wheel 1839 may be powered by a motor on the cart 1837. The motor may therefore be configured to move the mirrored display 1872. In some embodiments, the cart 1837 may move the mobile display 1835 along the floor of a room.

In some embodiments, the mirrored display 1872 may be independent of and/or disconnected from an exercise device. Put another way, the mirrored display 1872 may not be connected to an exercise device. When performing an exercise activity, the motor may be configured to rotate the wheels 1839 or other motive element to move the mirrored display 1872 across the floor to move into view of the user.

As may be seen in FIG. 18-2, an exercise system 1800 may include a plurality of exercise devices (collectively 1841). A mobile display 1835 may be movable between the exercise devices 1841 to allow the user to view the same display regardless of which exercise device 1841 or exercise station the user is using. In some embodiments, the exercise devices 1841 may be any type of exercise device. For example, the exercise devices 1841 may include a treadmill, an elliptical machine, a rower, a cable driven exercise device, a free weight station, a yoga mat, a body weight exercise station, a plyometrics station, any other exercise device or station, and combinations thereof. In some embodiments, an exercise device 1841 may not include a display. Put another way, an exercise device 1841 may be a headless (e.g., without a console) exercise device. The mobile display 1835 may move between the exercise devices 1841 to provide a common display for the user.

In some embodiments, the mobile display 1835 may follow a display path 1843. As the user moves between exercise devices 1841, the mobile display 1835 may move so that the mobile display 1835 is visible to the user and/or so that the user is visible within a mirrored or reflective portion of the mobile display. In some embodiments, the display path 1843 may be a pre-determined path. For example, a motive element for the mobile display 1835 may be track on the floor and/or the ceiling, and the mobile display 1835 may move along the path. In some embodiments, the mobile display 1835 may include pre-programmed instructions with direct the wheels to rotate a pre-determined amount of times to travel along the path. In some embodiments, the mobile display 1835 may be directed and/or oriented by position sensors (such as the sensors 1283 of FIG. 12).

In some embodiments, the mobile display 1835 may move between one or more display stations 1845. At each display station 1845, the mobile display 1835 may be visible to the user using an exercise device 1841. In this manner, a mobile display 1835 may be used for an entire exercise system. Many exercise programs include a user to move between different exercise devices 1841. Including a single mobile display 1835 may reduce the communication required between the different exercise devices 1841.

During a sample exercise program, a user may exercise at a first exercise device 1841-1 while viewing the mobile display 1835 when it is in the first station 1845-1. The user may move to the second exercise device 1841-2 and begin a second exercise. When the user moves, the mobile display 1835 may move along the display path 1843 to the second station 1845-2. The user may view the mobile display 1835 at the second station 1845-2 while using the second exercise device 1841-2. When the user moves to the third exercise device 1841-3, the mobile display 1835 may move along the display path 1843 to the third station 1845-3. The user may view the mobile display 1835 at the third station 1845-3 while using the third exercise device 1841-3.

### INDUSTRIAL APPLICABILITY

This disclosure generally relates to devices, systems, and methods for exercise storage systems. In some embodiments, an exercise storage system includes a storage compartment. In some embodiments, the storage compartment may include exercise equipment. The exercise equipment may include any piece of exercise equipment. For example, the exercise equipment may include an exercise machine, such as a treadmill, a stationary bicycle, an elliptical machine, a rowing machine, or any other exercise machine. In some embodiments, the exercise machine may include a collapsible or foldable exercise machine, and the exercise machine may fold into the storage compartment. In this manner, the storage container may be unobtrusive and/or attractive compact storage for the exercise machine.

As discussed above, the exercise machine may include a collapsible or a foldable treadmill. In some embodiments, the foldable treadmill may include a front end connected to a cable. A support on the cabinet may be connected to a spool connected to the cable. A motor may cause the spool to wind. This may cause the cable to lift the front end of the treadmill deck. In some embodiments, the deck may be lifted while exercising, causing an increase in the incline experienced by the user. In some embodiments, the deck may be lifted into a storage position inside the storage container. In some embodiments, the treadmill (or any exercise machine) may be completely stored within the storage container. In other words, a door of the exercise container may completely close an opening of the storage container, fully containing and removing the treadmill from view.

The storage compartment may include one or more storage elements, such as shelves, hooks, and so forth, on which exercise equipment may be placed. Any exercise equipment may be placed on the storage elements, such as weights, barbells, kettle balls, resistance bands, jump ropes, mats, gloves, clothes, shoes, any other exercise equipment, and combinations thereof.

The cabinet may include a door. The door may close over an opening in the cabinet. The opening in the cabinet may open to the storage features. Thus, when closed, the door may block access to the storage equipment. In some embodiments, the door may include an inner face and an outer face. The inner face may be the face of the door that faces the opening when the door is closed, and the outer face may be the face of the door that faces outward when the door is closed.

In some embodiments, the outer face of the door may include a display. The display may include a mirrored surface. The mirrored surface may allow a user to view himself while exercising. This may allow the user to examiner his form while exercising. In this manner, the user may critique and correct his form for exercises, which may help reduce injury, improve muscle strength, improve flexibility, and combinations thereof. Furthermore, because the mirrored surface is located on the door, it is conveniently located near the exercise equipment. This may allow the user to transition between exercises quickly and smoothly, without wasting time by walking from the cabinet to a mirror or exercise station.

In some embodiments, the display may include a backlit display, such as a monitor, a television, or other backlit display. When lit, the backlit display may be visible through the mirrored surface. The backlit display may present one or more exercise programs through the mirrored surface. The user may follow instructions on the exercise program to perform an exercise. In some embodiments, the exercise program may include instructions regarding the performance of exercises, including exercises using the exercise equipment stored in the cabinet.

In some embodiments, the backlit display may include a touchscreen display. For example, the user may be able to interact with the backlit display by touching the display. The user may provide input to the backlit display, respond to queries and other input from the backlit display, and otherwise interact with the backlit display. In this manner, the user may not need to keep track of a remote or install an application on a mobile device to interact with the display and/or the exercise program shown on the display.

In some embodiments, the display may include a one-way mirror. In other words, the display may include the mirrored surface and a backlit display. The backlit display may be visible through the mirrored surface, and the mirrored surface may still be mirrored. In this manner, the user may view herself on the mirrored surface and view the backlit display. Thus, the user may perform the exercises as instructed by the exercise program, and compare her execution of the exercises to the performance shown on the exercise program. This may improve the user experience, improve the user's exercise form, and allow the user to more effectively perform exercises.

In some embodiments, the door may be connected to the cabinet body with a hinge. The hinge may allow the outer face of the door to maintain an adjustable viewing angle. For example, the user may desire for the display on the outer face of the door to face the user, even when the door opens. Conventional hinges change the viewing angle of the door by angling the outer face of the door away from the storage compartment when opening. A hinge according to embodiments of the present disclosure may allow the outer face of the door to face the user, even as the door is opened. This may allow the user to access the exercise equipment while facing the display (e.g., the mirrored surface and the backlit display).

In some embodiments, the hinge may be connected to a first side of the cabinet body with a rotating connection. The hinge may rotate with a first axis of rotation at the first side of the cabinet body. In some embodiments, the hinge may be connected to the inner face of the door with a rotating connection. In some embodiments, the hinge may be connected to the inner face of the door at a middle position of the door. In other words, the hinge may be connected to the door at a position between a first edge and a second edge of the door. The hinge may rotate about a second axis of rotation at the connection to the inner face of the door.

In some embodiments, the door may be opened by rotating the hinge about the first axis of rotation. This may move the door away from the opening of the cabinet. The viewing angle of the display may be adjusted by rotating the hinge about the second axis of rotation. This may change the orientation of the door relative to the user. Thus, the user may orient the door according to her needs and preferences.

In some embodiments, the door may open such that the outer face is facing the same direction as the opening. In other words, the outer face may be parallel to the opening when in an open position, and the outer face may remain pointed in the same direction as in a closed position. As discussed above, this may allow the user to face the display and easily access exercise equipment from the opening, without significantly changing position.

In some embodiments, in the closed position, the door may latch to the storage compartment at an upper portion of the storage compartment. In some embodiments, the door may latch to the storage compartment at a second side of the storage compartment.

In some embodiments, the hinge may include a first lateral member and a second lateral member. The first lateral member may be rotatably connected to the cabinet at the cabinet first wall and rotatably connected to the door at the inner face of the door. The second lateral member may be rotatably connected to the cabinet at the cabinet first wall and rotatably connected to the door at the inner face of the door. A wall shaft may connect the first lateral member and the second lateral member at the cabinet wall. A door shaft may connect the first lateral member and the second lateral member at the door. In some embodiments, the wall shaft may be rotatably connected to the cabinet wall, and the door shaft may be rotatably connected to the door. In this manner, the hinge may be strong and support a heavy door. In some embodiments, the hinge may include any number of lateral members, such as 1, 2, 3, 4, 5, 6, 7, 8, or more lateral members.

In some embodiments, the door shaft may be movable along the width of the inner face of the door. For example, the door shaft may be slidably mounted on a rail. Thus, the position of the door may be adjustable based on the position of the door shaft. In at least one embodiment, this may allow the user to place the door closer to, further away from, and/or at a specific angle relative to the cabinet. In this manner, the user may arrange the door during an exercise activity based on personal preference, the activity performed, the space available, any other reason, and combinations thereof.

In some embodiments, when the door is open, the door may be moved such that, when the outer face of the door faces the same direction as the opening of the storage compartment, the display does not overlap any portion of the storage compartment. In this manner, the user may access the exercise equipment inside the storage compartment without moving the door.

In some embodiments, the display may be mounted to the outer face of the door with an adjustable connection. For example, the display may be mounted to the outer face of the door with a sliding connection, and the display may have a vertically adjustable position. For example, the display may be slidably mounted on brackets, and the display may vertically move on the brackets. In at least one embodiment, a vertically adjustable display may allow the user to customize and/or optimally locate the display for use during an exercise activity. This may allow the user to place the display in a position with a better view and/or to view different portions of his body in the mirrored display during exercise activities. For example, when the user is performing a shoulder press with free weights, the user may wish to have the display located vertically higher to better view himself. In some examples, when the user is performing a yoga move while sitting down, crouching, or resting a portion of his weight on his hands, the user may wish to have the display located vertically lower to better view himself. In some examples, different users may have different heights; a taller user may place the display at a higher position than a shorter user.

In some embodiments, the vertical position of the display may be manually adjustable. In other words, the vertical position of the display may be changed by an application of an upward or a downward force by the user. In some embodiments, a motor may change the vertical position of the display. For example, a worm gear, linear motor, hydraulic piston, pneumatic piston, or other electronic and/or electromechanical system may change the vertical position of the display.

In some embodiments, a vertical angle of the display may be adjustable. For example, the display may be mounted to the door with a display hinge, and the display may be vertically rotated about the display hinge. In at least one embodiment, this may allow the user to change the display angle of the display. In this manner, the user may orient the display as desired. For example, the user may wish to orient the display downward to change the angle with which she may view herself performing an activity, and thereby observe and/or critique her form. Similarly, the user may wish to orient the display upward to better view the form of an elevated activity, such as pull-ups or other elevated activity.

In some embodiments, the vertical angle of the display may be manually adjustable. In other words, the vertical angle of the display may be changed by an application of a torque about the display hinge by the user. In some embodiments, a motor may change the vertical angle of the display. For example, a motor may rotate the display hinge. In some embodiments, the upper portion or the lower portion of the display may be moved linearly to change the display angle. For example, the upper portion of the display may be moved manually, or with a motor, such as a worm gear, linear motor, hydraulic piston, pneumatic piston, or other electronic and/or electromechanical system may change the vertical angle of the display.

In some embodiments, the display may further be configured with computer functionality to receive input from the user and provide output to the user, and/or configured to control the exercise machine. For example, the console may be employed in connection with motors to control the opening and closing of the door and the backlit display discussed above in order to allow the user to manually or programmatically alter the position of the display during the course of a workout on the exercise machine. The display may be configured to communicate over a network (e.g. a Bluetooth network, a WiFi network, or the Internet) with other similar exercise machines, with servers, with computing devices of personal trainers, and with sensors such as heart rate and respiration sensors, etc.

Furthermore, the display may be capable of downloading and uploading data in order to, for example, download and upload workouts, data gathered at the exercise storage system, and data gathered at other exercise machines, etc. The display may enable a user of the exercise machine to compete with a user of another similar or dissimilar exercise machine, that is local to or remote from the user, with the competing users competing in real-time or at different times. Further, the display may be configured to track the amount of repetitions performed by the user, the weight used, and other exercise data, during a workout in order to compute the number of calories burned, the amount of energy expended, the amount of work performed, or any other metric or statistic desired by the user. Further, the display may be configured to track the number of barbell lifts and weight lifted, the number of dumbbell lifts and weight lifted, and any other exercise performed in connection with the exercise machine in order to track the number of calories burned, the amount of energy expended, the amount of work performed, or any other metric or statistic desired by the user during a workout using the exercise machine.

In some embodiments, all data tracked or downloaded by the display may be presented to the user on the backlit display on a display of another device, such as a tablet or smartphone that is connected via Bluetooth with the console. Further, the display, or another device connected to the display, may be configured to guide a user through a workout using the exercise machine. This guidance may be audible guidance, visual guidance, or some combination of the two, including guidance that employs video depicting exactly what a user should do to follow the workout. In this manner, a user can have the benefit of a trainer without a human trainer present.

In some embodiments, the exercise storage system may provide guidance for a user. For example, the door may include a light projector. The light projector may be located behind the mirrored surface, and may project light, such as a laser or other light, onto a surface. The projected light may include lasers or other projected visual indicators to assist a user in performing a workout properly. For example, the projected light may be employed to show a user a location to place their feet, to show a user how far to step or jump, to show a user how to properly position their hips, knees, joints, head, shoulders, or any other body part to properly perform a cable or free weight exercise. In some embodiments, the location may include marks that are displayed on the surface. In some embodiments, the location may include a projection of the body part to be placed at that location.

Further, the console may be configured to function as a real-time live video interface to a human trainer who can guide a user through a workout on the exercise machine without the human trainer being present. Further, live or pre-recorded workout sessions may be displayed on the console, or another connected device, such as live studio sessions, powerlifting sessions, full-body sculpting sessions, and world-class coaching sessions. Further, the console may be configured such that a remote trainer, a live video feed, or a pre-recorded video feed or workout can control the resistance or other parameters of the exercise machine. Also, the display may be configured with multiple user profiles to store preferences and other settings for more than one user.

In some embodiments, an exercise storage device may include two resistance arms. When the door is closed, the user may extend one or both of the resistance arms and perform resistance based exercises. For example, the user may pull on the handles, which may be connected to a flywheel within the storage compartment. The resistance arms may be rotatable with respect to the storage compartment. For example, the resistance arms may be rotated into a storage position, in which the resistance arms are parallel or substantially parallel to the storage compartment. The resistance arms may be further rotatable into different extended positions, which may allow the user to exercise different muscles and muscle groups.

The display includes a backlit display that is located behind a mirrored surface. The backlit display may display an exercise program. The exercise program may include many exercises, including exercises that may use the resistance arms. The backlit display may further include input features, in which the user may select an exercise program, change a resistance level of the resistance arms, and otherwise interact with the exercise program. The backlit display may display any information, including instructions on how to perform an exercise, videos of a trainer or other user performing the exercise, performance statistics, including calories burned, repetitions performed, and so forth, and combinations of the foregoing.

In some embodiments, an exercise storage system may include multiple indicator lights and multiple storage sensors. For example, each storage element may include a plurality of indicator lights and/or a plurality of storage sensors. In some embodiments, each piece of exercise equipment (such as dumbbells, the kettle bells, the shoes, the yoga mats, the jump ropes, and so forth) may be associated with an indicator light and a storage sensor on a storage element.

In some embodiments, each piece of exercise equipment may have a specific storage location. For example, a dumbbell having a certain weight may have a specific storage location in the exercise storage system. The storage sensor may identify the piece of exercise equipment that is placed on or near it. If the piece of exercise equipment placed on or near the sensor is not the specific piece of exercise equipment assigned to that particular location (and storage sensor), then a notification may notify the user that the piece of equipment is not installed in the appropriate location. The notification may include an audible notification, a visual notification (e.g., the indicator light highlighting and/or flashing on the piece of equipment), any other notification, and combinations thereof.

In some embodiments, the piece of equipment may include one or more sensors. For example, the piece of equipment may include a tracking sensor that is configured to track the use and/or the location of the piece of equipment. The tracking sensor may track motions performed with the piece of equipment, and use those motions to determine a repetition count, track a user's form, direct the location of the backlit display, and so forth.

In some embodiments, the storage sensor may be used to determine the presence and/or identity of the piece of equipment. When the piece of equipment is removed from the exercise storage system, the identity of the piece of equipment may be communicated to a computing system. In some embodiments, the computing system may determine that the user is performing an exercise activity using the identified piece of equipment based on whether it has been removed from the exercise storage system. In some embodiments, when the piece of equipment is placed in the exercise storage system, the storage sensor may identify the piece of equipment and the location where it was placed. In this manner, a certain piece of equipment may not need to have a specific location within the exercise storage system. In some embodiments, the storage sensor may identify the piece of equipment using any identification mechanism, such an RFID receiver, receipt of a communication, visual identification of a bar or QR code, any other identification mechanism, and combinations thereof.

In some embodiments, when the identified piece of equipment is removed from the exercise storage system, the computing system may connect to the tracking sensor on the piece of equipment. For example, when the identified piece of equipment is removed from the exercise storage system, the storage sensor may communicate the removal to the computing system. The computing system may then attempt to communicate with the tracking sensor in the identified piece of equipment, and may then receive exercise information from the tracking sensor. In some embodiments, the tracking sensor may be dormant, or in a no- or low-powered state. When the piece of equipment is removed from the exercise storage system, the storage sensor may instruct the tracking sensor to power up, or to transition to an active state. The tracking sensor may then connect with the computing system to provide exercise and/or location data to the computing system.

In some embodiments, the tracking sensor on the piece of equipment may be charged in the exercise storage system. For example, the storage element may include a charging element. The charging element may be configured to align with the tracking sensor and provide charging power to the tracking sensor. In some embodiments, the charging element may be a wireless charging system, such as a Qi charging system. In some embodiments, the charging element may be a wired charging system, including contacts on the charging element that align with contacts on the tracking sensor.

In some embodiments, a mirrored display may include a display surface. The display surface may be mirrored, such that an object presented in front of the mirrored display may be reproduced on the display surface. The display surface may include a backlit display. The backlit display may be displayed behind the mirrored display. The backlit display may present information to the user that the user may view on the display surface. In some embodiments, the display surface may be both mirrored and include a backlit display, such that the object may be viewed on the display surface simultaneously with the backlit display.

In accordance with embodiments of the present disclosure, the mirrored display may be connected to a support with a display connection. For example, the support may be a storage cabinet, as disclosed herein. In some embodiments, the support may include a wall-mountable bracket that is mounted to the wall. In some embodiments, the support may be an exercise device, such as a stationary bicycle, an elliptical device, a treadmill, a rower, a cable exercise device, and so forth.

In some embodiments, the display connection may be a hinge that connects the mirrored display to the support. In some embodiments, the display connection may be a rotatable connection, such that the mirrored display may rotate relative to the support. In some embodiments, the display connection may be connected to the support with a support hinge, and the support hinge may be rotatable. In some embodiments, the display connection may be connected to the mirrored display at a display hinge, and the display hinge may be rotatable. In some embodiments, both the support hinge and the display hinge may be rotatable. In some embodiments, the mirrored display is rotatable about the display hinge and/or the support hinge, both of which have a rotational axis that is parallel to a force of gravity. In some embodiments, the mirrored display may be rotatable about a rotational axis that is perpendicular to the force of gravity. In some embodiments, the mirrored display may be rotatable about a rotational axis that is perpendicular to the force of gravity and about a rotational axis that is parallel to the force of gravity.

In accordance with embodiments of the present disclosure, the mirrored display may face the object such that the object is within a field of view of the mirrored display. The field of view may be the area in front of the mirrored display in which the object may be clearly viewed in the mirrored display surface, and/or the backlit display on the display surface can be clearly viewed by a user performing an exercise. For example, the object may be a user performing an exercise activity. The field of view may be the area in which the user may see himself perform an activity on the mirrored display while viewing visual information displayed on the mirrored display. In some embodiments, the object may be an exercise accessory, and the field of view may be the area in which the object may be visible to a user on the mirrored display and/or detectable by a sensor. In some embodiments, the exercise accessory may include any exercise accessory, such as a ball (e.g., a basketball, a football, a soccer ball, a lacrosse ball, a baseball, a tennis ball, a racquet ball, a squash ball, a cricket ball, a golf ball, a bouncy ball, or any other type of ball), a bat, a weight, a kettle bell, a rope, a jump rope, a pole, a fencing sword, a racquet, any other exercise accessory, and combinations thereof.

In some embodiments, the user may view the mirrored display along a viewing path, thereby creating a viewing angle between the mirrored display and the viewing path. The viewing angle may be the smallest angle defined by the viewing path and the display surface. In some embodiments, when the viewing angle is not a right angle (e.g., when the viewing angle is not 90°), the viewing angle may be acute. The viewing angle may be determined from a viewpoint, which may be a location on the mirrored display. In some embodiments, the viewpoint may be located in the center of the mirrored display. In some embodiments, the viewpoint may be located at any point on the mirrored display. For example, the viewpoint may be located at an outer edge of the mirrored display. In some embodiments, locating the viewpoint in the center of the mirrored display may allow the user to move with respect to the mirrored display while retaining a visible viewing angle, as discussed herein.

In some embodiments, the information displayed (e.g., the mirrored object and/or the backlit display) on the display surface may be visible to the object and/or the user based on the viewing angle. If the viewing angle becomes too small, then the information displayed (e.g., the mirrored object and/or the backlit display) on the display surface may not be visible to the user.

In some embodiments, the viewing angle at which information on the display surface is visible may be the visible viewing angle. In some embodiments, the visible viewing angle may be in a range having an upper value, a lower value, or upper and lower values including any of 45°, 50°, 55°, 60°, 65°, 70°, 75°, 80°, 85°, 90°, or any value therebetween. For example, the visible viewing angle may be greater than 45°. In another example, the visible viewing angle may be less than 90°. In yet other examples, the visible viewing angle may be any value in a range between 45° and 90°. In some embodiments, it may be critical that the visible viewing angle is greater than 60° to allow the user to view both a reflected image and a backlit image simultaneously on the display surface.

In some embodiments, the mirrored display and/or the display surface may have an optimal viewing angle. The optimal viewing angle may be the angle at which the user can see both the object (e.g., the user and/or the exercise accessory) reflected in the display surface and the backlit display in the display surface. In some embodiments, the optimal viewing angle may be such that the object is reflected on top of (e.g., over, overlaid) the backlit display. For example, the object may be reflected on top of the backlit display to provide the user with a comparison between videos or images in the backlit display and the reflected object. In some embodiments, the optimal viewing angle may be such that the object is not reflected on top of the display surface, or is not reflected on top of a portion of the display surface. For example, the object may be reflected to the side of, above, below, or otherwise not on top of information presented in the display surface. This may allow the user to observe without obstruction by the object the information presented on the display surface (such as exercise instructions, motivational information, a recreational video, other information, and combinations thereof), while still having a view of the object. In some embodiments, the optimal viewing angle may be a user-defined setting. In some embodiments, the optimal viewing angle may be assigned by the mirrored display based on an activity being performed.

In some embodiments, the optimal viewing angle may be in a range having an upper value, a lower value, or upper and lower values including any of 45°, 50°, 55°, 60°, 65°, 70°, 75°, 78°, 80°, 82°, 84°, 86°, 88°, 90°, or any value therebetween. For example, the optimal viewing angle may be greater than 45°. In another example, the optimal viewing angle may be less than 90°. In yet other examples, the optimal viewing angle may be any value in a range between 45° and 90°. In some embodiments, it may be critical that the optimal viewing angle is 60° to ensure that all of the visual information presented on the display surface is visible as intended.

As a user performs exercise activities, the object (e.g., the user and/or an exercise accessory controlled by the user) may move relative to the mirrored display. This may cause the viewing angle to change. In some embodiments, the object may move such that the viewing angle is reduced to less than the visible viewing angle. When the viewing angle is less than the visible viewing angle, the user may not be able to see or may only partially see, the information displayed on the display surface.

In some embodiments, the mirrored display may determine that the object has moved if the object has moved outside of a field of view of the mirrored display and/or if the object has moved outside of a field of view of the sensor. The mirrored display may then be moved in the direction that the object moved before it moved out of the field of view until the object enters the field of view again.

In some embodiments, the user may perform one or more exercise activities based on a pre-programmed, livestreamed, or otherwise scheduled exercise program. The exercise program may, for example, be scheduled and administered by ICON Health and Fitness' iFit exercise program. Throughout the course of an exercise program, the user may move based on one or more changes in exercise activities and/or based on the movements performed during the exercise. In some embodiments, the movements of the user may be inferred and/or determined based on the scheduled exercise activity. For example, a user may perform a first exercise activity on a stationary bicycle, and the mirrored display may face the user while the user uses the stationary bicycle.

In some embodiments, the exercise program may include any type of exercise activity. For example, the exercise program may include aerobic exercise, such as activities performed on an exercise machine (e.g., a stationary bicycle, a treadmill, an elliptical machine, a rower), dances, aerobics, any other aerobic exercise, and combinations thereof. In some examples, the exercise program may include anaerobic exercise, such as activities performed with a weight machine, a cable exercise device, free weights, body weight exercises (e.g., push-ups, pullups, squats, pull-ups), any other anaerobic exercise, and combinations thereof. In some embodiments, the exercise program may include sports activities, such as basketball exercises, soccer exercises, baseball exercises, golf exercises, any other sport activity, and combinations thereof. In some embodiments, the exercise program may include any other exercise activity, including stretching exercises, yoga, Pilates, plyometrics, cross-fit, power lifting, any other exercise activity, and combinations thereof. In some embodiments, the mirrored display may be configured to face the user and/or one of the user's exercise accessories while performing an exercise activity. In some embodiments, the exercise program may include any combination of exercise activities discussed herein.

In some embodiments, the exercise program may include a scheduled second exercise activity, such as weight-based exercise (e.g., free-weights, kettle bells, body weight). To perform the second exercise activity, the user dismounts the stationary bicycle and moves away from the stationary bicycle to where the weight-based exercise activity is performed. Based on the scheduled change in exercise activities, the mirrored display may automatically change position (e.g., without external input from a sensor, without external input from the user) so that it faces the location of the weight-based exercise activity. In some embodiments, the exercise program may include pre-determined positions for the mirrored display for each exercise activity of an exercise program. For example, the exercise program may include a first pre-determined position for the first exercise activity (e.g., in the first pre-determined position, the mirrored display may face a first location where the user will likely perform the first exercise activity, such as where equipment for the first exercise activity is located). The exercise program may further include a second pre-determined position (e.g., in the second pre-determined position, the mirrored display may face a second location where the user will likely perform the second exercise activity, such as where equipment for the second exercise activity is located) for the second exercise activity. It should be understood that the exercise program may include any number of pre-determined positions for any number of exercise activities to be performed during an exercise program.

During the first exercise activity of the exercise program, the mirrored display may be in the first pre-determined position. When the exercise program transitions to the second exercise activity, the mirrored display may change position to the second pre-determined position. This may occur, for example, while the user is changing positions to transition between the first exercise activity and the second exercise activity. In some embodiments, even if the user does not perform the second exercise activity, the mirrored display may transition between the first pre-determined position and the second pre-determined position as the pre-programmed exercise program progresses.

After the second exercise activity is completed, the mirrored display may automatically change position to face the location of the next exercise activity. In this manner, the mirrored display may continually face the user, regardless of the exercise being performed by the user. This may improve the exercise experience by reducing the need for the user to manually move the mirrored display and/or provide input to have the mirrored display move.

In some embodiments, a sensor on the mirrored display may sense position information from the object and the mirrored display (or a computing system connected to the sensor) may determine the position of the object. The mirrored display may then determine whether the object is visible on the display surface. If the mirrored display determines that the object is visible on the display surface, then the mirrored display may perform no action (e.g., the mirrored display may remain in the same position). If the mirrored display determines that the object is not visible on the display surface, then the mirrored display may change position so that the object becomes visible on the display surface (e.g., so that the object moves into the display surface and becomes visible to the user).

In some embodiments, the mirrored display may determine that the object is visible on the display surface if the viewing angle is greater than, equal to, or less than the visible viewing angle. If the viewing angle is greater than or equal to the visible viewing angle, then the mirrored display may perform no action (e.g., the position and/or angle of the mirrored display may remain the same). If the viewing angle is less than the visible viewing angle, then the mirrored display may change position so that (e.g., until) the object is visible on the display surface. In some embodiments, the mirrored display may change positions until the viewing angle is at an optimal viewing angle.

In some embodiments, the position of the mirrored display may be changed by rotating the mirrored display and/or the display connection to increase the viewing angle to greater than the visible viewing angle. For example, the mirrored display may change position by rotating about the display hinge. In some examples, the mirrored display may change position by rotating about the support hinge (e.g., the display connection may rotate about the support hinge, thereby rotating the mirrored display about the support hinge). In some examples, the mirrored display may change position by rotating about both the display hinge and the support hinge. In some embodiments, the mirrored display may change position by translating. For example, the lateral position of the display hinge relative to the mirrored display may be changed. In some examples, the lateral position of the support hinge relative to the support may be changed. In some embodiments, the lateral position of both the display hinge and the support hinge may be changed. In some embodiments, the mirrored display may change position by both rotating and translating.

In some embodiments, the exercise system may include one or more display motors connected to the mirrored display. The display motor may cause the mirrored display to change positions. For example, the display motor may be connected to one or both of the support hinge or the display hinge. The display motor may apply a torque to the mirrored display about the support hinge and/or the display hinge, thereby causing the mirrored display to rotate. In some embodiments, the display motor may cause the mirrored display to rotate about a rotational axis that is parallel to the force of gravity (e.g., an axis that extends through the support hinge or the display hinge). In some embodiments, the display motor may cause the mirrored display to rotate about a rotational axis that is perpendicular to the force of gravity. In some embodiments, the motor may cause the mirrored display to rotate about a first rotational axis that is parallel to the force of gravity and a second rotational axis that is perpendicular to the force of gravity. In some embodiments, the display motor may include a linear motor that causes the mirrored display to move the mirrored display laterally and/or vertically.

In some embodiments, the position of the mirrored display may be changed until the viewing angle reaches the optimal viewing angle. In some embodiments, the position of the mirrored display may be changed until the viewing angle reaches a minimum visible viewing angle (e.g., the minimum angle at which the object may be seen in the display surface and/or the backlit display is visible on the display surface). In some embodiments, the position of the mirrored display may be changed until the object enters the field of view.

In some embodiments, the mirrored display may track the viewing angle of an object relative to a viewer. For example, the mirrored display may receive position information for a first object and a second object. The mirrored display may determine a position and/or viewing angles for one or both of the first object and the second object. In some embodiments, the first object may be a first user and the second object may be a second user. The first user (e.g., the first object) may perform an exercise activity, such as dancing, boxing, wrestling, martial arts sparring, coaching/training, and so forth, with the second user (e.g., the second object). During the course of the exercise activity, the second user may move away from the first user. In some embodiments, the mirrored display may track the second user as the second user moves away from the first user. As the second user moves out of the field of view and/or the viewing angle of the second user reduces to below the visible viewing angle, the mirrored display may change position such that the second user may be visible and/or view the backlit display of the display surface. In other words, the mirrored display may prioritize the second user over the first user. Thus, if the second user moves far enough away from the first user, the mirrored display may change position sufficiently that the first viewing angle is reduced to below a visible viewing angle for the first user. In some embodiments, the mirrored display may prioritize the first user over the second user. Thus, when the second user moves away from the first user, the mirrored display may remain fixed on the first user.

In some embodiments, when the second user and the first user move apart from each other, the mirrored display may change position such that the first user and the second user have the same or similar viewing angles. In other words, the mirrored display may track the first viewing angle of the first user and the second viewing angle of the second user, and the mirrored display may change position so that the first viewing angle and the second viewing angle are the same or approximately the same. In this manner, even when the first user and the second user are separated during an exercise activity (either because the users are exercising separately or because the activity causes them to separate), both users may be able to view the information displayed (e.g., their respective reflections and/or the backlit display) on the display surface. It should be understood that any number of objects (e.g., users and/or exercise accessories) may be used with the mirrored display. For example, the mirrored display may change position so that three, four, five, six, or more users may see the information displayed on the display surface.

In some embodiments, the first object may be a user and the second object may be an exercise accessory. In some embodiments, the user may utilize the exercise accessory and the exercise accessory may move away from the user. For example, a user may be performing sports drills (e.g., dribbling exercises) that cause the exercise accessory to move away from the user. In some embodiments, the mirrored display may stay facing the user while the exercise accessory moves away from the user. In some embodiments, the mirrored display may change position to keep the exercise accessory in view of the mirrored display. In some embodiments, the mirrored display may change position so that the user may still see herself and the exercise accessory in the display surface as the exercise accessory moves away from the user.

In some embodiments, the mirrored display may change positions to face the object using a combination of both pre-determined positions and sensed locations of the object. For example, the mirrored display may transition between a first pre-determined position and a second pre-determined position based on a transition between exercise activities. After the mirrored display has moved to the second pre-determined position, the sensor may sense the location of the user, and the mirrored display may make small adjustments to its position based on the exact location of the user. For example, the sensor may track the reflected light from the user's iris to determine the user's viewing path and the viewing angle. Based on the determined viewing path and viewing angle, the mirrored display may fine-tune its position to optimize the viewing experience for the user. By automatically moving into the second pre-determined position, the mirrored display may prevent losing track of the object if the object moves faster than the sensor can track it (e.g., the object may move out of the sensing range of the sensor before the sensor can adjust). This may improve the exercise experience by ensuring that the mirrored display is always facing the user during exercise activities.

In some embodiments, the position of the mirrored display may be determined based on a piece of exercise equipment that is selected by the user. For example, a use storage sensor may be associated with each piece of exercise equipment. The mirrored display may be in communication with the use storage sensor for each piece of exercise equipment. When a user picks up a piece of exercise equipment, the use storage sensor may communicate which piece of exercise equipment the user picked up. Based on the selected exercise equipment and/or the place in the exercise program, the mirrored display may infer an exercise activity that is being performed and/or a location for the activity to be performed.

In some embodiments, the exercise equipment may include a sensor. When the piece of exercise equipment is selected by the user and removed from the exercise storage system, the use storage sensor may cause a sensor (such as the receptor) to be activated. In this manner, the mirrored display may be able to track activities being performed by the user and/or which equipment the user is using.

In some embodiments, an object (e.g., a user) may be performing an exercise activity in front of the mirrored display. The mirrored display may be located in a first position and the user may be able to view information displayed on a display surface of the mirrored display. For example, the display surface may display information from a backlit surface and/or present a reflected image of the object.

In some embodiments, the mirrored display may detect a viewing angle of the object. The viewing angle may be the angle at which the object views information on the display surface across the viewing path. In some embodiments, the user is performing an exercise activity in an upright position, and the mirrored display is positioned such that the user can view the information displayed on the display surface.

In some embodiments, an exercise activity may cause the user to change vertical position. For example, the user may perform an exercise on the ground, such as a yoga activity, a stretch, a mindfulness activity, and so forth. The mirrored display may detect the position of the user and/or the viewing angle generated by the viewing path and the mirrored display. In some embodiments, based on the viewing angle, the mirrored display may change position to increase the viewing angle to a visible viewing angle. In some embodiments, the mirrored display may rotate about a display hinge with a rotational axis that is perpendicular to the force of gravity to change the viewing angle. In some embodiments, the mirrored display may translate vertically to change the viewing angle.

In some embodiments, the mirrored display may include a motion sensor. The motion sensor may capture motion information about a user (e.g., the object). In some embodiments, while the user is performing an exercise activity, the motion sensor may capture information related to the exercise activity. For example, the user may be performing an exercise activity that utilizes a specific body posture (e.g., form). The motion sensor may capture the form of the user, including relative positioning, angles, and orientations of the user's limbs, torso, head, hands, feed, exercise accessories, and combinations thereof.

In some embodiments, the mirrored display may display the information on the display surface. For example, the mirrored display may present a skeleton or schematic view of the user performing an exercise next to or overlaid over an example of the “proper” form, or the body position of the exercise activity that may promote a specific muscle strengthening and/or prevent injury. In some embodiments, the example may be in the form of a trainer or other video of a person performing the exercise activity. In some embodiments, the example may be in the form of a schematic or cartoon image of a person performing the exercise activity.

In some embodiments, the motion sensor may only capture motion of the user, without capturing video images of the user. This may help to provide the user of his or her privacy while utilizing the exercise system.

In some embodiments, an object (such as a user and/or an exercise accessory) may perform an exercise activity inside the room. One or more sensors (collectively) may track the object as it moves about the room during the exercise activity. When the object moves away from the mirrored display, the sensor may communicate the position to the mirrored display, and the mirrored display may change position to face the object.

In some embodiments, a display sensor may be located on the mirrored display. In this manner, the display sensor may easily sense and determine the position of the object relative to the mirrored display. In some embodiments, a sensor may be located remotely from the mirrored display. For example, one or more room sensors may be located within the room. The room sensors may communicate the position of the object to the mirrored display. In some embodiments, utilizing a room sensor may help to determine the absolute location of the object within the room. In some embodiments, a plurality of room sensors may triangulate the position of the object within the room. In some embodiments, the exercise system may include a display sensor and one or more room sensors.

In some embodiments, one or more of the room sensors may be located outside of a field of view of the mirrored display. Thus, in some embodiments, the mirrored display may receive position information about the object from a room sensor located outside of a field of view of the mirrored display. In some embodiments, one or more of the room sensors may be located outside of the field of view (e.g., the sensing area) of the display sensor. Thus, in some embodiments, the mirrored display may receive position information about the object from a room sensor that is located outside of a field of view of the display sensor.

While embodiments of the present disclosure have discussed a display sensor located on the mirrored display, it should be understood that the display sensor may be located anywhere else in the exercise system, such as on the support. In some embodiments, the display sensor may be integrally formed with the mirrored display. In some embodiments, the display sensor may be separately formed and placed on the mirrored display. For example, the display sensor may be placed the top of the mirrored display and/or adhered (e.g., magnetically, with one or more suction cups, with an adhesive) to the mirrored display.

Similarly, while the room sensors have been described as being located on the walls of the room, it should be understood that the room sensors may be located in any remote location from the mirrored display. For example, the room sensors may be located on the ceiling, on the floor, on a table, on a stand, suspended from the ceiling, or any other location within the room. In some embodiments, the room sensors may be dedicated to the exercise system. In some embodiments, the room sensors may be present in the room when the exercise system is installed, such as security cameras.

In some embodiments, the sensor may be any type of sensor. For example, the sensor may be a camera, a motion sensor, a distance sensor, a LIDAR sensor, any other type of sensor, and combinations thereof. In some embodiments, the sensor may be a facial tracking sensor that tracks where a user's face is located. In some embodiments, the sensor may track reflected light from a user's eyes (e.g., the iris). In some embodiments, the sensor may be optimized to track wavelengths of light that reflect well from the user's iris.

In some embodiments, the object may include a tracking device. For example, the object may include a receiver, such as a radio frequency identification (RFID) receiver, motion-capture sensors, infrared receivers, and so forth. The sensor may ping and receive responses from the receiver to determine the location of the object relative to the sensor and/or the mirrored display. In some embodiments, the object may include other motion-capture sensors and/or receivers that may communicate the motions of the object to the mirrored display and/or the sensors. In some embodiments, the object may include a receiver that includes one or more motion sensors, such as one or more of accelerometers, force sensors, torque sensors, and so forth. The receiver may use dead reckoning (e.g., incremental changes in position added together to determine a net change in position over time) to determine the position of the object. The receiver may then communicate the position information to the mirrored display. In some embodiments, the user and/or the receiver may identify a starting position for the object and use dead reckoning to determine changes in position to the object.

In some embodiments, an exercise system may include a position tracking manager. The position tracking manager may be in communication with a tracking sensor. The tracking sensor may be any position sensor, motion sensor, a receiver on an object, any other sensor discussed herein, any other senor, and combinations thereof. In some embodiments, the position tracking manager may receive position information from the tracking sensor. The position tracking manager may include a position determiner. The position determiner may utilize the position information received from the tracking sensor to determine the position of the object (e.g., the user and/or an exercise accessory). In some embodiments, the position determiner may determine the position of the object relative to a mirrored display. In some embodiments, the position determiner may determine the absolute position of the object in a room or other exercise area.

The position tracking manager includes a display controller. Based on the determined position, the display controller may control one or more display motors connected to the mirrored display. The display motor may control a position of the mirrored display. For example, the display motor may control a rotational position, a lateral position, a vertical position, or combinations thereof, of the mirrored display. In some embodiments, the display controller may cause the mirrored display to change positions to face the tracked object such that the tracked object is visible in the mirrored display.

In some embodiments, the position tracking manager may include a timeout. The timeout may be used to determine whether the object is moving too fast to be effectively tracked. For example, a user may be performing an exercise activity that involves fast lateral movements that take him or her in and out of the field of view of the mirrored display. In some embodiments, the display controller and/or the display motor may not be able change position of the mirrored display fast enough to track the user. In some embodiments, such fast movements of the mirrored display my cause undue wear and tear on the mirrored display, the display motor, the hinge or support supporting the mirrored display, or combinations thereof. Furthermore, when performing a high-movement activity, the user may not focus on the mirrored display.

To prevent the mirrored display from moving around too much, the display controller may consult a timeout to determine if the object has stayed in one position for a timeout period, such as 1 s, 2 s, 3, s, 4, s, 5, s, 10 s, 15 s, 20 s, 25 s, 30 s, or any value therebetween. If the object has stayed in one position for the timeout period, then the display controller may cause the display motor to move the mirrored display to face the object. In some embodiments, the display controller may determine that the object has stayed in one position if the object does not move a timeout distance during the timeout period. For example, the timeout distance may be 1 in., 2 in., 3 in., 4 in., 5 in., 6 in., 9 in. 12 in., 18 in, 24 in., or any value thereof. It should be understood that any combination of timeout distances and/or timeout periods may be combined to determine whether mirrored display will be moved to face the user.

In some embodiments, a method for exercise tracking may be implemented by and/or with the exercise systems discussed herein. The method includes receiving position information of an object. The position information may be received from a tracking sensor, from a receiver on the object, from an exercise program, from any other source, and combinations thereof. In some embodiments, using the position information, the position of the object relative to a mirrored display may be determined. Based on the determined position of the object, the mirrored display may be caused to change position.

In some embodiments, a method for exercise tracking may include receiving position information for an object and determining a position of the object. In some embodiments, the method may include determining whether the object is outside of a visual area of a mirrored display. For example, the method may include determining whether the viewing angle of the object (e.g., a user) to the mirrored display is greater than a visual angle. If the object is not outside of the visual area of the mirrored display, then the method may loop back to receiving the position information. If the object is outside of the visual area of the mirrored display, then the method may cause a motor to move the mirrored display to track the object.

In some embodiments, an exercise storage system includes a storage compartment. A mirrored display is connected to the storage compartment. The mirrored display may include a mirrored surface that reflects a large amount of light. When a user is performing an exercise in front of the mirrored display, the user may be reflected in the mirrored display. The mirrored display may further include a backlit display. The backlit display may allow the user to view content on the mirrored display while performing an exercise. Because the mirrored display is both highly reflective and includes a backlit display, a user may be able to use the mirrored display to simultaneously receive instruction from the backlit display and compare his or her form in the reflective surface.

As discussed herein, the mirrored display, may be connected to the storage compartment with a hinge. The hinge may be connected to a motor. The motor may cause the mirrored display to change position. In some embodiments, the motor may cause the mirrored display to rotate 90°. In some embodiments, the mirrored display may be in the “portrait” orientation. In the portrait orientation, the height of the mirrored display may be greater than the width, where the height of the mirrored display is measured parallel to the force of gravity. The motor may rotate the mirrored display about an axis transverse (e.g., not parallel) or perpendicular to the force of gravity. In some embodiments, the motor may rotate the mirrored display about an axis that is perpendicular to the plane of the mirrored display.

The mirrored display may be rotated into the “landscape” orientation. In the landscape orientation, the width of the mirrored display may be larger than the height of the mirrored display, where width is measured perpendicular to the force of gravity. Changing orientations of the mirrored display may allow for different viewing configurations for the user. Some exercise activities and/or exercise programs may utilize video or other media that is oriented in the landscape orientation. Indeed, a user may desire to check his or her form for some exercise activities in the landscape orientation. For example, in many body weight exercises the user's body is oriented parallel to the force of gravity, such as during a pushup. In the landscape orientation, more of the user's body may be visible in the landscape orientation, thereby allowing the user to more closely analyze his or her form. In some embodiments, a user may utilize an exercise device that may benefit from the landscape orientation. For example, in a rower, the user's body and motions may be more fully visible and/or larger in the landscape orientation. This may allow the user to inspect and correct his or her form while remaining in the mirrored display, without the mirrored display moving to keep the user in view. This may help to improve the user experience.

While the mirrored display is connected to a storage device in the embodiments shown, it should be understood that the mirrored display may be connected to any exercise device. For example, the mirrored display may be connected to a treadmill, an elliptical machine, a rower, a cable strength exercise device, any other exercise device, and combinations thereof. In some embodiments, the mirrored display may not be connected to an exercise device. For example, the mirrored display may be connected to a wall, to the floor, suspended from the ceiling, freely supported on its own structure, and combinations thereof. This may allow the mirrored display to be used with any exercise device and with multiple exercise devices.

In some embodiments, an exercise system may have a split mirrored display. The split mirrored display includes a first portion and a second portion. The first portion and the second portion may be independently movable. Put another way, the first portion may be independently movable from the second portion. The first portion may be connected to a storage system with a first motor and the second portion may be connected to the storage system with a second motor. The first motor and the second motor may be independent, and may move their respective portions independently.

In some embodiments, the first portion and the second portion may be configured as a coordinated display to display coordinated content. Coordinated content may include content that is displayed over both the first portion and the second portion. For example, coordinated content may include a picture or a video that is continuous across a break between the first portion and the second portion. In this manner, the first portion and the second portion may combine to form a combined display that can display larger or more content than either the first portion or the second portion individually.

In some embodiments, the first portion and the second portion may be configured to simultaneously (e.g., at the same time) display independent content. For example, the first portion may display a first image or video and the second portion may display a second image or video. This may allow a group of users to exercise together in different locations in the same room, work on different exercises simultaneously, work at different exercise stations, and so forth. In some embodiments, different independent content on the first portion and the second portion may allow the user to move between exercise stations at different locations in an exercise room without one or both of the first portion or the second portion moving.

In some embodiments, the first portion may be independently movable from the second portion. For example, the second portion may be laterally moved. This may allow the user to quickly change position and retain a functional viewing angle of one or both of the first portion or the second portion without either of them moving.

While the second portion is described as moving laterally, it should be understood that the first portion and/or the second portion may be moved in any direction discussed herein. For example, the first portion and/or the second portion may be moved vertically (e.g., parallel to a force of gravity), rotated about an axis parallel to the force of gravity, rotated about an axis perpendicular to the force of gravity and parallel to the plane of the first portion and/or the second portion, rotated about an axis perpendicular to the force of gravity and perpendicular to the plane of the first portion and/or the second portion, moved in any other direction, and combinations thereof. In this manner, the first portion and/or the second portion may be oriented to face the user in a variety of different locations, orientations, and positions.

In some embodiments, the first portion and the second portion may be independently moved and oriented at different orientations. For example, the first portion and the second portion have different angular orientations relative to the storage compartment. This may allow a first user to exercise in front of the first portion and a second user to exercise in front of the second portion, and for both users to see their reflection in the mirrored surface. Exercising with friends or other people is often more enjoyable, and this may improve the exercise experience.

In some embodiments, a mobile display may include a mirrored display mounted to a cart. The mirrored display may be any mirrored display discussed herein. The cart may be a wheeled cart that includes at least one wheel or other motive element. The wheel may be powered by a motor on the cart. The motor may therefore be configured to move the mirrored display. In some embodiments, the cart may move the mobile display along the floor of a room.

In some embodiments, the mirrored display may be independent of and/or disconnected from an exercise device. Put another way, the mirrored display may not be connected to an exercise device. When performing an exercise activity, the motor may be configured to rotate the wheels or other motive element to move the mirrored display across the floor to move into view of the user.

In some embodiments, an exercise system may include a plurality of exercise devices. A mobile display may be movable between the exercise devices to allow the user to view the same display regardless of which exercise device or exercise station the user is using. In some embodiments, the exercise devices may be any type of exercise device. For example, the exercise devices may include a treadmill, an elliptical machine, a rower, a cable driven exercise device, a free weight station, a yoga mat, a body weight exercise station, a plyometrics station, any other exercise device or station, and combinations thereof. In some embodiments, an exercise device may not include a display. Put another way, an exercise device may be a headless exercise device. The mobile display may move between the exercise devices to provide a common display for the user.

In some embodiments, the mobile display may follow a display path. As the user moves between exercise devices, the mobile display may move so that the mobile display is visible to the user and/or so that the user is visible within a mirrored or reflective portion of the mobile display. In some embodiments, the display path may be a pre-determined path. For example, a motive element for the mobile display may be track on the floor and/or the ceiling, and the mobile display may move along the path. In some embodiments, the mobile display may include pre-programmed instructions with direct the wheels to rotate a pre-determined amount of times to travel along the path. In some embodiments, the mobile display may be directed and/or oriented by position sensors.

In some embodiments, the mobile display may move between one or more display stations. At each display station, the mobile display may be visible to the user using an exercise device. In this manner, a mobile display may be used for an entire exercise system. Many exercise programs include a user to move between different exercise devices. Including a single mobile display may reduce the communication required between the different exercise devices.

During a sample exercise program, a user may exercise at a first exercise device while viewing the mobile display when it is in the first station. The user may move to the second exercise device and begin a second exercise. When the user moves, the mobile display may move along the display path to the second station. The user may view the mobile display at the second station while using the second exercise device. When the user moves to the third exercise device, the mobile display may move along the display path to the third station. The user may view the mobile display at the third station while using the third exercise device.

Below are sections of the systems and methods of exercise storage systems of the present disclosure:

A1. An exercise system, comprising:
a mirrored display, the mirrored display including:
   a first portion; and
   a second portion;
a first motor connected to the first portion; and
a second motor connected to the second portion, wherein the first portion and the second portion are independently movable.
   A2. The system of section A1, wherein the first portion and the second portion are configured to display a coordinated display.
   A3. The system of section A1 or A2, wherein the first portion and the second portion are configured to display independent content.
   A4. The system of any of sections A1-A3, wherein the first motor is configured to rotate the first portion about a first axis, and wherein the second motor is configured to rotate the second portion about a second axis independently of the first axis.
   A5. The system of any of sections A1-A4, wherein the first portion is oriented above the second portion.
   A6. The system of any of sections A1-A5, further comprising at least one sensor, wherein the first motor and the second motor are connected to the at least one sensor.
   A7. The system of section A6, wherein the at least one senor tracks a first object and a second object.
   A8. The system of section A7, wherein the first motor directs the first portion to the first object and the second motor directs the second portion to the second object.
   B1. An exercise system, comprising:
a mirrored display including a display surface, the display surface including a mirrored surface and a backlit display; and
a motor connected to the mirrored display, wherein the motor changes a position of the mirrored display, wherein the motor rotates the mirrored display about an axis perpendicular to a plane of the mirrored display.
   B2. The exercise system of section B 1, wherein the motor rotates the mirrored display about an axis transverse to a force of gravity.
   B3. The exercise system of section B1 or B2, wherein the motor rotates the display 90° from a portrait orientation to a landscape orientation.
   B4. The exercise system of any of sections B1-B3, wherein the motor causes the mirrored surface to rotate about a rotational axis parallel to a force of gravity.
   B5. The exercise system of any of sections B1-B4, wherein the motor causes the mirrored surface to rotate about a rotational axis perpendicular to a force of gravity.
   B6. The exercise system of section B5, further comprising a plurality of tracking sensors, wherein the motor moves the mirrored display based on a sensed position from the plurality of tracking sensors.
   B7. The exercise system of section B6, wherein at least one tracking sensor of the plurality of tracking sensors is located remotely from the mirrored surface.
   C1. An exercise system, comprising:
an exercise device;
a mirrored display independent of the exercise device;
a motor configured to move the mirrored display; and
a processor and memory, the memory including instructions which, when executed by the processor, cause the processor to move the mirrored display relative to the exercise device.
   C2. The system of section C1, wherein the mirrored display is disconnected from the exercise device.
   C3. The system of section C1 or C2, wherein the exercise device does not include a display.
   C4. The system of any of sections C1-C3, wherein the instructions further cause the processor to move the mirrored display based on an exercise program.
   C5. The system of any of sections C1-C4, further comprising a wheeled mount, the mirrored display being connected to the wheeled mount, and wherein the motor is configured to rotate one or more wheels on the wheeled mount to move the mirrored display relative to the exercise device.
   D1. An exercise system, comprising:
a mirrored display including a display surface, the display surface including a mirrored surface and a backlit display;
a tracking sensor configured to sense a position of an object relative to the mirrored surface; and
a motor connected to the mirrored surface, wherein the motor changes a position of the mirrored surface based on the sensed position of the object.
   D2. The exercise system of section D1, wherein the tracking sensor is connected to the mirrored display.
   D3. The exercise system of any of sections D1-D2, wherein the tracking sensor tracks reflected light from a user's iris.
   D4. The exercise system of any of sections D1-D3, wherein the motor causes the mirrored surface to rotate about a rotational axis parallel to a force of gravity.
   D5. The exercise system of any of sections D1-D4, wherein the motor causes the mirrored surface to rotate about a rotational axis perpendicular to a force of gravity.
   D6. The exercise system of any of sections D1-D5, wherein the tracking sensor includes a plurality of tracking sensors.
   D7. The exercise system of section D6, wherein at least one tracking sensor of the plurality of tracking sensors is located remotely from the mirrored surface.
   E1. A method for exercise tracking, comprising:
receiving position information of an object;
using the position information, determining a position of the object relative to a mirrored display; and
causing the mirrored display to change position based on the determined position of the object relative to the mirrored display.
   E2. The method of section E1, wherein receiving the position information includes receiving the position information from a tracking sensor.
   E3. The method of any of sections E1-E2, wherein receiving the position information includes receiving an indication of a change in exercise activity.
   E4. The method of any of sections E1-E3, wherein determining the position of the object includes determining that the position of the object is outside of a field of view of the mirrored display.
   E5. The method of any of sections E1-E4, wherein receiving the position information includes receiving the position information from a plurality of tracking sensors.
   E6. The method of section E5, wherein receiving the position information includes receiving the position information from at least one tracking sensor of the plurality of tracking sensors that is located outside of a field of view of the mirrored display.
   E7. The method of any of sections E1-E6, wherein the object includes at least one of a basketball, a lacrosse ball, a baseball, or a golf ball.
   E8. The method of any of sections E1-E7, wherein receiving the position information includes receiving position information from a plurality of tracking sensors.
   E9. The method of any of sections E1-E8, wherein causing the mirrored display to change position includes causing the mirrored display to rotate to face the object.

F1. An exercise system, comprising:
an exercise storage system;
a mirrored display connected to the exercise storage system;
a tracking sensor in communication with the mirrored display;
a processor and memory, the memory including instructions which, when executed by the processor, cause the processor to:
receive position information of an object from the tracking sensor;
determine a position of the object relative to the mirrored display using the position information; and
cause a change to a position of the mirrored display based on the determined position of the object.
   F2. The system of section F1, wherein the tracking sensor is connected to the mirrored display.
   F3. The system of any of sections F1-F2, wherein causing the mirrored display to change position includes causing the mirrored display to rotate to face the object.
   F4. The system of any of sections F1-F3, further comprising a motor connected to the mirrored display that causes the change to the position of the mirrored display.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An exercise system, comprising:
a mirrored display including a display surface, the display surface including a mirrored surface and a backlit display;
a tracking sensor configured to sense a position of an object relative to the mirrored surface; and
a motor connected to the mirrored surface, wherein the motor changes a position of the mirrored surface based on the sensed position of the object.

2. The exercise system of claim 1, wherein the tracking sensor is connected to the mirrored display.

3. The exercise system of claim 1, wherein the tracking sensor tracks reflected light from a user's iris.

4. The exercise system of claim 1, wherein the motor causes the mirrored surface to rotate about a rotational axis parallel to a force of gravity.

5. The exercise system of claim 1, wherein the motor causes the mirrored surface to rotate about a rotational axis perpendicular to a force of gravity.

6. The exercise system of claim 1, wherein the tracking sensor includes a plurality of tracking sensors.

7. The exercise system of claim 6, wherein at least one tracking sensor of the plurality of tracking sensors is located remotely from the mirrored surface.

8. A method for exercise tracking, comprising:
receiving position information of an object;
using the position information, determining a position of the object relative to a mirrored display; and
causing the mirrored display to change position based on the determined position of the object relative to the mirrored display.

9. The method of claim 8, wherein receiving the position information includes receiving the position information from a tracking sensor.

10. The method of claim 8, wherein receiving the position information includes receiving an indication of a change in exercise activity.

11. The method of claim 8, wherein determining the position of the object includes determining that the position of the object is outside of a field of view of the mirrored display.

12. The method of claim 8, wherein receiving the position information includes receiving the position information from a plurality of tracking sensors.

13. The method of claim 12, wherein receiving the position information includes receiving the position information from at least one tracking sensor of the plurality of tracking sensors that is located outside of a field of view of the mirrored display.

14. The method of claim 8, wherein the object includes at least one of a basketball, a lacrosse ball, a baseball, or a golf ball.

15. The method of claim 8, wherein receiving the position information includes receiving position information from a plurality of tracking sensors.

16. The method of claim 8, wherein causing the mirrored display to change position includes causing the mirrored display to rotate to face the object.

17. An exercise system, comprising:
an exercise storage system;
a mirrored display connected to the exercise storage system;
a tracking sensor in communication with the mirrored display;
a processor and memory, the memory including instructions which, when executed by the processor, cause the processor to:
receive position information of an object from the tracking sensor;
determine a position of the object relative to the mirrored display using the position information; and
cause a change to a position of the mirrored display based on the determined position of the object.

18. The system of claim 17, wherein the tracking sensor is connected to the mirrored display.

19. The system of claim 17, wherein causing the mirrored display to change position includes causing the mirrored display to rotate to face the object.

20. The system of claim 17, further comprising a motor connected to the mirrored display that causes the change to the position of the mirrored display.
